(19) United States
(12) Patent Application Publication
(10) Pub. No.: US 2007/0067236 A1
(43) Pub. Date: Mar. 22, 2007

(54) Method and system for advancing funds

(76) Inventors: Che Karana Deinhardt, Redland Bay Queensland (AU); Raymond Robert Brisbane, Springwood Queensland (AU)

Correspondence Address: WINSTON & STRAWN LLP;PATENT DEPARTMENT, 1700 K STREET, N.W., WASHINGTON, DC, 20006, US

(21) Appl. No.: 11/518,381

(22) Filed: Sep. 8, 2006

Related U.S. Application Data
(63) Continuation of application No. PCT/AU05/00345, filed on Mar. 11, 2005.

(30) Foreign Application Priority Data
Mar. 11, 2004 (AU) 2004901256
Dec. 13, 2004 (AU) 2004907081

(51) Int. Cl. G06Q 40/00

(52) U.S. Cl. 705/39

(57) ABSTRACT

A method for providing funds to a first party based upon accounts receivable due to a first party includes calculating an amount of accounts receivable due to the first party from accounts receivable debtors of the first party or from a portion of the accounts receivable debtors. A second party then transfers funds to the first party based on the amount of accounts receivable due to the first party. As the accounts receivable and any applicable penalty payments are collected from the accounts receivable debtors, the collected amounts receivable and applicable penalty payments are provided to the second party. Systems and platforms for implementing the method are also provided.

### CROSS-REFERENCE TO RELATED APPLICATIONS

This application is a continuation of International application PCT/AU2005/000345 filed Mar. 11, 2005, the entire content of which is expressly incorporated herein by reference.

### FIELD OF THE INVENTION

The present method relates in general to methods and systems for advancing funds to a party, such as a business enterprise. In some aspects, the present invention relates to a method for recovering accounts receivable due to a first party. The present invention, in other aspects, relates to methods and systems for advancing or transferring funds to a party based upon expected revenues.

### BACKGROUND TO THE INVENTION

Recovery and collection of accounts receivable is a perennial problem for creditors. Most businesses and government organisations issue accounts to their customers or clients with a specified payment date mentioned on the account. Typical payment periods (often referred to as normal trading terms) could be 7 days, 14 days or 30 days from the date of issue of the account. Some businesses and government organisations provide discounts for early or on-time payment of accounts. Some businesses and government organisations apply penalty payments for late payment of accounts. Such penalty payments may take the form of a sliding scale of payments that increase with the age of the debt or they may take the form of penalty interest applicable to the late payment and calculated on the amount owing and the period elapsing between the due date or account date and the payment date.

Late payment of accounts receivable by debtors impacts negatively on the business or government organisation that issued the accounts. Late payment of accounts receivable can cause cash flow difficulties to the party that issued the accounts. Late payment can require the party that issued the account to obtain bank or other lending organisation finance to provide operating cash flow to run the business. Such finance attracts interest that is payable by the party that issued the account, thereby negatively impacting on the profit of that party. The party that issues the account may also have to employ additional staff in their accounting section to recover aged debts or outsource collection of aged debts to outside collection agencies. In either case, increased costs follow.

Several strategies have been implemented by businesses and government organisations over the years to recover accounts receivable. One strategy involves breaking the accounts receivable ledger into accounts receivable by age and selling the aged or older debts to a debt collection agency. Typically, it is the oldest debts that are sold to the debt collection agency. This debt is normally sold to the debt collection agency for a discounted amount that is substantially less than the book value of the debt. This substantial reduction is provided to cover the risk of bad debts being uncollectable by the debt collection agency. This strategy suffers from the disadvantage that the party that issued the accounts does not recover the book value of the aged debt. A further disadvantage of this strategy arises in that debt collection agencies that purchase aged debt tending to adopt aggressive collection techniques, which can lead to increased consumer complaints. Such consumer complaints typically impact adversely on the party that issued the initial account. However, this strategy does allow the party issuing the accounts to avoid chasing aged debts, thereby reducing administrative burden and potentially reducing staff requirements. Cash flow is also improved as the payment from the debt collection agency for the aged debt is received before collection of the debt occurs.

Another strategy to recover funds from accounts receivable is factoring or, as it is sometimes called, cash flow lending. In factoring, a factoring firm takes control of a party's book debts, usually paying between 75-80% of the book value of the debt to the party that issued the accounts. The factoring firm may pay up front or it may pay a percentage upfront, the remainder on collection and charge interest and fees on the transaction. Factoring improves cash flow and enables outsourcing of debt administration. However, the party that issued the accounts only receives a discounted amount for the book value of its debts and it may incur further charges from the factoring firm. Typically, the party that issued the accounts also maintains the risks of non-collection of bad debts.

A number of businesses and government organisations deal with the issue of aged debtors, in part, by applying penalty payments to slow payment. For example, local councils in Queensland are authorised under applicable state legislation to charge penalty interest on late payment of rates notices. Solicitors in New South Wales are also empowered to charge penalty interest on late payments. Other businesses may enter into credit contracts with their debtors that include clauses in which the debtors agree to penalties for late payment. Although such penalty payments provide an incentive for debtors to pay within the agreed trading terms, they do not address the issues of cash flow problems caused by late payment and increased administrative load and staffing load to properly administer collection of aged debts.

A number of businesses also sign contracts with credit card providers to receive payment for sales. The credit card providers typically charge between 1% and 5% of the sales price for providing the credit card facilities. Although the businesses have to pay those fees to the credit card providers, the businesses benefit from not having to chase debtors. However, opportunities do exist for alternative funding methods and funding products based upon actual revenue or anticipated or expected revenue.

### BRIEF DESCRIPTION OF THE INVENTION

In one aspect, the present invention is based upon a business obtaining enhanced value from its accounts receivable.

To briefly explain this aspect of the present invention and without limiting the generality of the present invention, consider normal business practice in which a business issues invoice to customers for goods or services supplied by the business or the customer. Such invoices will include payment terms, which are frequently 30 days. This means that the customer can pay the invoice in a timely fashion by paying the invoice up to 30 days after the date of the invoice. It will be realised that the business has already supplied the goods or services to the customer at this stage. Effectively, the business is providing a credit to the customer and, for the 30 day period of the invoice, the business is effectively out of pocket. For late payment, the business may impose penalty interest, late payment fees or other penalty charges.

According to an embodiment of the present invention, a funding party will advance to the business an amount of funds equal to a percentage of the amount invoiced to customers, with these funds suitably being transferred to the business immediately or very shortly after the invoices have been issued by the business. For example, the funding party may advance 99% of the total amount invoiced one day after the invoices were issued. Thus, the business receives funds that correspond to 99% of the total invoiced, but those funds are received one day after the date of the invoice, rather than up to 30 days after the invoice date. The payments collected from the customers of the business are provided to the funding party, together with any penalty payments that may apply for late payment. In situations where the invoices are fully paid, the funding party receives payment totalling 100% of the invoices plus any penalty payments. Although the business may forgo a small percentage of the total amount invoiced, this is more than compensated by the business receiving the funds from the funding party significantly earlier than if it was to await payment from its customers.

In other embodiments of the invention, the funding party may advance funds to the business on the basis of anticipated revenue, rather than on the basis of issued invoices.

Unlike known methods of providing finance to businesses, some embodiments of the present invention allow the business to receive funds from the funding party and only have to repay those funds following collection of payments from customers. Thus, embodiments of the present invention are not restricted to rigid payment schedules in which set payments must be made on set dates to the funding party. This provides greater control over cash flow management for the business. Indeed, the present invention provides a unique financial product never before offered.

The invention allows for all relevant terms and conditions to be negotiated between the business and the funding party. The business effectively receives immediate payment of its invoices whilst the funding party has a new financial product to offer. The funding party may also have the opportunity to provide appropriate collection mechanisms to receive payments from customers, which may allow the funding party to receive enhanced fees and extra margin whilst, at the same time, allowing the business to reduce back office costs and lower the all-in cost of funds. In some embodiments, the funding party may also generate and issue the invoices on behalf of the business enterprise.

The invention also includes appropriate systems or platforms to implement the methods of the invention. Again, without limiting the generality of the present invention, the systems or platforms may include appropriate computer programs and network communications.

In a first aspect, the present invention provides a method for providing funds to a first party based upon accounts receivable due to the first party, said accounts receivable including penalty payments for late or overdue payment, the method including the steps of:

(a) calculating an amount of accounts receivable due to the first party from the accounts receivable debtors or from a portion of the accounts receivable debtors of the first party;

(b) transferring funds from the second party to the first party for the amount of accounts receivable due to the first party as calculated in step (a) above; and

(c) collecting the accounts receivable and any applicable penalty payments from the accounts receivable debtors, the collected accounts receivable and applicable penalty payments being provided to the second party.

Step (a) of the method of the present invention involves calculating an amount of the accounts receivable due to the first party from the accounts receivable debtors, or from a portion of the accounts receivable debtors, of the first party. This step may incorporate calculating the total amount owing to the first party from all accounts receivable of the first party. In this embodiment, the amount calculated in step (a) is simply the sum of all outstanding debt owing to the first part, from current accounts to very old outstanding accounts.

Alternatively, the amount calculated in step (a) may be calculated from a portion of the accounts receivable debtors of the first party. For example, the amount calculated in step (a) may be based upon all accounts receivable older than 30 days, or 60 days, or another convenient debtor age selection. For example, if a debtor age of 30 days is chosen as the appropriate debtor age, the amount calculated in step (a) is the total of all outstanding debtors older than 30 days.

In another alternative embodiment, the amount calculated in step (a) may be determined by:

(i) calculating the total accounts receivable owing to the first party to obtain a first amount;

(ii) calculating a provision for current accounts receivable likely to be paid within normal trading terms;

(iii) deducting the provision of step (ii) from the first amount to determine a second amount.

In this embodiment, the provision for current accounts receivable likely to be paid within normal trading terms may be calculated by use of historical data that shows the proportion of current accounts that are not timely paid. In this embodiment, funds collected from current accounts that are timely paid may be provided to the first party whilst funds collected from late payment of accounts and applicable penalty payments are provided to the second party. In this manner, the first party simply collects its on-time payments in the normal course and the second party provides funds to the first party based on the amount of old debtors likely to arise from the current accounts receivable.

A further variation of this embodiment of the present invention may be used if the first party provides discounts or concessions or settlement fees or accepts a lower amount for early payment or on-time payments of debts. In this embodiment, step (ii) above may further comprise making a second provision equal to the discount applicable to the amount of accounts receivable within normal trading terms and step (iii) further comprises deducting the provision and the second provision from step (ii) from the amount calculated in step (i) and step (b) involves transferring that amount from the second party to the first party.

In yet a further embodiment, step (a) may comprise calculating an amount of accounts receivable arising from current accounts receivable (that is, debts that have not yet been paid but for which the normal trading period has not yet expired).

A further embodiment may involve calculating the total amount owing to the first party from all accounts receivable of the first party and multiplying that amount by an agreed percentage to determine the amount in step (a).

In another embodiment, step (a) may comprise calculating the amount from all accounts receivable that have not been paid and have moved beyond normal trading terms since the calculation was previously calculated. This embodiment is used as part of an ongoing application of the method of the present invention.

Once the method of the present invention has been implemented for a first time, ongoing implementation of the method will typically involve performing subsequent calculations to determine the amount owing to the first party due to accounts receivable (or a portion thereof) and transferring further funds from the second party to the first party. In this embodiment, the method of the present invention includes the steps of:

(a) making an initial calculation of an amount of accounts receivable due to the first party from the accounts receivable debtors or from a portion of the accounts receivable debtors of the first party;

(b) transferring funds from a second party to the first party equal to the initial amount calculated in step (a) above;

(c) collecting the accounts receivable and applicable penalty payments from the accounts receivable debtors, the collected accounts receivable and applicable penalty payments being provided to the second party;

(d) performing a subsequent calculation within a predetermined period of a previous calculation, said subsequent calculation calculating a subsequent amount of accounts receivable due to the first party from the accounts receivable debtors or from a portion of the accounts receivable debtors of the first party that have arisen in the period between the previous calculation and the subsequent calculation;

(e) transferring funds equal to the subsequent amount from the second party to the first party; and

(f) repeating steps (c) to (e) as required.

Step (b) of the present invention involves transferring funds from the second to the first party for the amount calculated in step (a) above. In some embodiments, the method of the present invention transfers an amount of funds equal to the calculated amount of the accounts receivable (it being appreciated that, depending upon the arrangement between the first and second parties, various provisions may be included in the calculation of the amount, for example, to account for current debt for which the first party receives payment within normal trading terms and/or to account for discounts applied by the first party for early payments or on-time payments). The quid pro quo of this arrangement for the second party arises from the second party receiving all payments for the accounts receivable (other than any payments that may be excluded by virtue of any provisions made in step (a)), including all penalty payments. Thus, the second party is transferring funds equal to the outstanding accounts receivable to the first party. The first party thereby receives early or on-time payment of all accounts receivable. In return, the second party receives all collected accounts receivable and all collected penalty payments.

The step of transferring funds from the second party to the first party may involve the second party loaning the funds to the first party. In this case, the interest payable on the loan is suitably low interest or zero interest.

The present invention provides the ability for the second party to contractually loan or transfer funds to the first party with the consideration being that the first party will charge their customers the applicable charges (default fees, finance fees, discounts, administration fees, etc) and forward such monies (both capital and charges) back to the second party, directly from the customers or via the first party or via a third party.

Suitably, the funds may be transferred from the second party to the first party within a short time, such as 0-3 or 1-3 days, from the date of issue of invoices.

The step for transferring funds from the second party to the first party suitably involves an electronic transfer of funds. Typically, the second party will establish an account holding funds, and funds will be transferred from that account to the first party. Alternatively, the second party may establish a credit facility with the lending institution and draw on that credit facility in order to transfer the funds from the second party to the first party.

Alternatively, the step of transferring the funds to the second party may involve establishing a line of credit for the first party to use as required or as it sees fit.

Step (c) of the method of the present invention provides collecting the accounts receivable and applicable penalty payments from the accounts receivable debtors, the collected accounts receivable and applicable penalty payments being provided to the second party.

Step (c) may comprise the first party collecting the accounts receivable and penalty payments from its debtors and transferring the collected funds to the second party. Alternatively, the second party may directly collect the accounts receivable and penalty payments. As a further alternative, a third party, such as a debt collection agency, may be engaged to collect the accounts receivable and penalty payments and the third party then provides the collected accounts receivable and penalty payments to the second party. It will be expected that the third party would receive a fee for collecting the accounts receivable and penalty payments. This fee could be a set fee per collection or it could be a percentage of the collected amount. The funds transferred to the second party may include all penalty payments or it may include a portion of the penalty payments.

In one embodiment, the accounts receivable are securitised accounts receivable. For example, the debts owing under the accounts receivable might be secured by statute or legislation enabling the first party to compulsory sell assets of the debtors to pay the accounts receivable. One example of this would be a local council having accounts receivable arising from rates notices. Applicable state government legislation in Australia authorises local councils to forcibly sell properties mentioned on rates notices if those rates notices are not paid, with the legislation also placing the local council at the head of any queue of creditors. Thus, in the event that a rates account is not paid, the council can compulsorily sell the land that is the subject of the rates notice to thereby recover the amount owing under the rates notice (including penalty payments). Thus, this debt is a secured debt.

In another embodiment, bad debts may be charged back to the first party, suitably at a nominal fee (for example, cost plus a small amount of interest). In another embodiment, bad debts are secured against bad debt insurance.

The method of the present invention is especially suitable for use in a computer environment. In one embodiment, step (a) may comprise the steps of:

(1) generating a plurality of accounts;

(2) entering details of the plurality of accounts into a computer program or computer database; and

(3) calculating the amount of accounts receivable from the details in the computer program or the computer database.

In one embodiment, step (3) above comprises calculating the total amount due from all accounts receivable. In another embodiment, step (3) comprises calculating a total amount due from all accounts receivable, making a provision for accounts likely to be paid early or on time and calculating the amount by subtracting the provision from the total amount.

In a further option of this embodiment, step (3) further includes the step of making a further provision for any discounts given by the first party for payment and calculating the amount by subtracting the provision and the further provision from the total amount.

In another embodiment, step (3) comprises monitoring payment of accounts receivable and calculating the amount by totalling all accounts receivable that fall overdue.

In a further embodiment, step (3) involves calculating the total accounts receivable and multiplying that amount by an agreed percentage.

Once the amount in step (a) has been calculated, in one embodiment, this information is provided to the second party. Suitably, this information may be provided over a computer network. The computer network may be the internet. Appropriate security protocols are suitably utilised. Appropriate interfaces may be required.

Upon receipt of the information from the first party, the second party transfers funds equal to the amount to the first party. The transfer of funds most conveniently occurs by electronic transfer, even more suitably by electronic fund transfer using a computer network, especially the internet.

The step of collecting the accounts receivable and penalty payments from the accounts receivable debtors is dependant upon the particular arrangement entered into by the first party and the second party. In one embodiment, the first party collects the debts and transfers the collected debts to the second party. This transfer may be an electronic transfer of funds, such as an electronic transfer of funds utilising a computer network, especially the internet. In another embodiment, the second party may be responsible for collecting the debts, in which case payment may involve a direct payment to the second party. In a further embodiment, a third party, such as a debt collection agency, may collect the outstanding debts. The debt collection agency may then transfer funds equal to the collected debts, including any penalty payments, to the second party. This transfer of funds may suitably be an electronic transfer of funds, more particularly any electronic transfer of funds utilising a computer network, especially utilising the internet.

As the debts are collected, the records of the first party or the second party or both are updated to show that payment of particular accounts receivable has been received. Such updating will typically involve data entry into a computer database or computer program followed by a recalculation of the amount to be collected.

This enables the first party or the second party or both to monitor the collection of payment of the accounts receivable and any applicable penalty payments.

The present invention also encompasses a system for implementing the method.

In a second aspect, the present invention provides a system for implementing the method of the first aspect of the present invention, the system including calculation means for calculating an amount of accounts receivable due to the first party from the accounts receivable debtors or from a portion of the accounts receivable debtors of the first party, funds transfer means for transferring funds from a second party to the first party, said funds transferred being equal to the amount calculated by the calculation means, and monitoring means for monitoring collection of the accounts receivable and applicable penalty payments.

The calculation means may comprise data entry means for entering data relating to the accounts receivable into a computer program or a computer database and a calculating program for calculating the amount from the data entered into the computer program or the computer database. The computer program or computer database may comprise a computerised spreadsheet. The calculating program may comprise part of the computerised spreadsheet. The calculation means may be installed in a network environment at one or both of a network of the first party or a network of the second party. Alternatively, the calculation means may be installed on a computer of the first party or a computer of the second party.

The monitoring means may include data entry means for entering data on the collection of accounts receivable and applicable penalty payments. The data entry means may be used to input data relating to payment of accounts receivable and applicable penalty payments into a computer program or computer database containing information in relation to accounts receivable and applicable penalty payments, and the monitoring means may further comprise updating means for updating the computer program or computer database to reflect payment of accounts receivable and penalty payments upon entry of such data from the data entry means.

The data entry means for entering data into a computer program or computer database in relation to the accounts receivable may comprise automated data entry means for automatically entering data when accounts are generated. The automated data entry means may comprise automated data entry means for automatically entering data when accounts are generated. The automated data entry means may comprise electronic data transfer means for transferring data that is generated by a computer upon issue of an account, said electronic data transfer means transferring data into a computer program or computer database.

The calculation means may include a computer program that calculates the amount in accordance with an agreed calculation method determined by the first party and the second party. The agreed calculation method may reflect the agreed calculation method of step (a) of the method of the first aspect of the present invention.

The system may further include information transfer means for transferring information on the accounts receivable from the first party to the second party. The information transfer means may includes a computer network, such as a local area network, a wide area network, or the internet. The information transfer means may also transfer updated accounts information from the monitoring means.

In a third aspect, the present invention provides a method for cash flow management based upon accounts receivable due to a first party, the method comprising:

a) calculating an amount of accounts receivable due to the first party from accounts receivable debtors of the first party or from a portion of the accounts receivable debtors;

b) transferring funds from a second party to the first party based on the amount of accounts receivable due to the first party as calculated in step (a) above; and

c) collecting the accounts receivable and any applicable penalty payments from the accounts receivable debtors, the collected accounts receivable and applicable penalty payments being provided to the second party.

Suitably, step (a) may be as described with reference to the first aspect of the present invention. Thus, in the third aspect, step (a) may comprise calculating an amount of the accounts receivable due to the first party from the accounts receivable debtors, or from a portion of the accounts receivable debtors, of the first party. This step may incorporate calculating the total amount owing to the first party from all accounts receivable of the first party. In this embodiment, the amount calculated in step (a) is simply the sum of all outstanding debt owing to the first part, from current accounts to very old outstanding accounts.

Alternatively, the amount calculated in step (a) may be calculated from a portion of the accounts receivable debtors of the first party. For example, the amount calculated in step (a) may be based upon all accounts receivable older than 30 days, or 60 days, or another convenient debtor age selection. For example, if a debtor age of 30 days is chosen as the appropriate debtor age, the amount calculated in step (a) is the total of all outstanding debtors older than 30 days.

In another alternative embodiment, the amount calculated in step (a) may be determined by:

(i) calculating the total accounts receivable owing to the first party to obtain a first amount;

(ii) calculating a provision for current accounts receivable likely to be paid within normal trading terms;

(iii) deducting the provision of step (ii) from the first amount to determine a second amount.

In this embodiment, step (b) involves transferring funds from the second party to the first party, said funds being transferred equalling the second amount.

In this embodiment, the provision for current accounts receivable likely to be paid within normal trading terms may be calculated by use of historical data that shows the proportion of current accounts that aren't timely paid. In this embodiment, funds collected from current accounts that are timely paid may be provided to the first part whilst funds collected from late payment of accounts and applicable penalty payments are provided to the second party. In this manner, the first party simply collects its on-time payments in the normal course and the second party provides funds to the first party based on the amount of old debtors likely to arise from the current accounts receivable.

A further variation of this embodiment of the present invention may be used if the first party provides discounts or concessions or settlement fees or accepts a lower amount for early payment or on-time payments of debts. In this embodiment, step (ii) above may further comprise making a second provision equal to the discount applicable to the amount of accounts receivable within normal trading terms and step (iii) further comprises deducting the provision and the second provision from step (ii) from the amount calculated in step (i) and step (b) involves transferring that amount from the second party to the first party.

In yet a further embodiment, step (a) may comprise calculating an amount of accounts receivable arising from current accounts receivable (that is, debts that have not yet been paid but for which the normal trading period has not yet expired).

In another embodiment, step (a) may comprise calculating the amount from all accounts receivable that have not been paid and have moved beyond normal trading terms since the calculation was previously calculated. This embodiment is used as part of an ongoing application of the method of the present invention.

Step (b) of the third aspect of the present invention provides for transferring funds from the second party to the first party based on the amount of accounts receivable due to the first party as calculated in step (a) above. In one embodiment, the amount of funds transferred to the first party may equal the amount calculated in step (a). In this embodiment, the third aspect of the invention is essentially identical to the first aspect of the invention.

In another embodiment of the third aspect of the present invention, the amount of funds transferred to the first party in step (b) equals a percentage of the amount calculated in step (a). The percentage may be agreed upon between the first party and the second party. The percentage may, for example, be between 90% and 99% of the total amount calculated in step (a), or between 95% and 99% of the amount, such that the amount of funds transferred equals 90-99%, or 95-99% of the amount calculated in step (a).

The funds transferred from the second party to the first party may be transferred shortly after the invoices for the accounts receivable have been generated. For example, the funds may be transferred within the period of 0-7 days after generation of the invoices, more preferably 0-5 days after, even more preferably 0-3 days after, still more preferably 0-1 day after, most preferably 1 day after generation of the invoices.

In this embodiment of the third aspect of the present invention, the first party calculates an amount of accounts receivable, for example an amount of accounts receivable following an invoice run or following an end of month calculation. The second party then provides an amount of funds to the first party that equals a percentage of the calculated amount of accounts receivable due to the first party. Those funds are then transferred very shortly after the amount has been calculated. Thus, the first party receives funds based upon the amount of accounts receivable, very shortly, most preferably one day, after generation of the invoices or after an end of month accounting run. The amount of funds transferred from the second party to the first party is most preferably a percentage of the amount calculated, for example 99% of the amount calculated. However, under the contractual arrangements between the first party and the second party, the first party is obliged to provide all of the collected accounts receivable plus any applicable penalty payments to the second party. Thus, in return for the first party receiving funds equivalent to 99% of its accounts receivable (in this case) within one day of generating the invoices, the first party provides funds to the second party that equal the amount of accounts receivable calculated in step (a) (i.e. 100% of the amount calculated in step (a)) and any applicable penalty payments. Thus, the first party returns funds to the second party that total a greater amount than the funds received from the second party. However, the first party has the benefit of an effective 1 day debtor collection period for 99% of its accounts receivable, which more than offsets the payments that must be made back to the second party. Further, as the first party receives its funds effectively very shortly after issue of invoices, the first party can use those funds to either reduce or retire other short term credit facilities or indeed invest those funds in short term interest bearing deposits or in other investments to use that money to create further money for the first company. The quid pro quo to the second company is that it is making a minimum 1% margin on the funds transferred, which margin is increased by virtue of the second party also being provided with any applicable penalty payments.

The step of transferring the funds to the first party may, in one embodiment, comprise establishing a line of credit for the first party.

A variation of the method of the first and third aspects of the present invention may also be used to provide funds to the first party based upon expected revenue for an upcoming period, for example, based upon expected sales revenue for an upcoming period. Accordingly, in a fourth aspect, the present invention provides a method for providing funds to a first party comprising:

a) estimating revenue for the first party for an upcoming period;

b) transferring funds from the second party to the first party based on the estimated revenue; and

c) providing collected revenue and any applicable penalty payments arising from the revenue generated during the period to the second party.

The method of the fourth aspect of the present invention may further comprise the step of issuing invoices by the first party in relation to sales for goods or services provided during the period and step (c) then comprises collecting money from customers or clients of the first party due to debts arising from invoices issued by the first party during the period, the collected money including any applicable penalty payments.

In this aspect of the present invention, step (a) may comprise estimating revenue for the first party for an upcoming period based upon historical revenue data for the first party for a previous corresponding period. The previous corresponding period may be an immediately proceeding period, or it may be an equivalent period from one or more previous years. The estimate may be based upon, for example, previous sales revenue for the corresponding period from the previous year. The estimate may be modified by including further historical data analysis to provide a trend analysis for revenue and modifying the revenue figure from the previous corresponding period by incorporating the trend line or trend analysis.

In a one embodiment, the method of the fourth aspect of the present invention may include:

a) estimating revenue for the first party for an upcoming period;

b) transferring funds from the second party to the first party based on the estimated revenue;

c)(i) generating invoices arising from sales or other revenue generation activity by the first party during the period,

c)(ii) collecting payment in respect of the invoices, said payment including any applicable penalty payments; and

c)(iii) providing the collected payments, including any applicable penalty payments, to the second party.

If the actual revenue generated during the period is less than the estimated revenue, the method may further comprise the first party repaying the difference between the actual revenue and the estimated revenue to the second party. this difference may attract interest for the period it was outstanding.

If the actual revenue exceeds the estimated revenue, the first party may simply recover that additional revenue. Alternatively, the invoices that relate to the additional revenue may be used as the basis for a further transfer of funds between the first party and the second party in accordance with the first aspect or the third aspect of the present invention. As a further alternative, the additional revenue may be used to reduce the amount of funds to be transferred from the second party to the first party on the basis of estimated revenue for a next upcoming period, it being appreciated that the method of the fourth aspect of the present invention is likely to be conducted on an ongoing basis.

In a fifth aspect, the present invention provides a method for providing funds to a business enterprise comprising:

a) calculating an amount due to the business enterprise, the amount calculated from accounts receivable due to the business enterprise or from an estimation of revenue for an upcoming period;

b) calculating funds payable by a funding enterprise to the business enterprise, the calculation of the funds being based upon the amount calculated in step (a);

c) transferring the funds to the business enterprise;

d) recovering money from customers of the business enterprise; and

e) providing the recovered money to the funding enterprise, the recovered money including any applicable penalty payments due to the business enterprise, said recovered money being provided to the funding enterprise after the money has been recovered from customers or clients of the business enterprise.

In this aspect of the invention, contractual arrangements between the business enterprise and the funding enterprise suitably do not have to set out a defined payment schedule in which specified payments are made by the business enterprise to the funding enterprise at specified dates. Instead, the contractual arrangements can allow the business enterprise to pay the recovered money to the funding enterprise as the money is recovered. For example, the contractual arrangement between the enterprises may require the business enterprise to make payments at 30, 60, 90 and 120 days after the funds had been advanced by the funding enterprise. However, the amounts payable at those due dates can be specified in the contractual arrangements to equal the amount of recovered money collected at those dates, less any payments previously made. This has the great advantage for the business enterprise in that cash flow is not squeezed if debtor days increases, as would happen if debtor days increased under a funding arrangement in which specified payments have to be made at specified dates. Instead, in the method of the fifth aspect of the present invention, the business enterprise only needs to pay the money that it has collected at the applicable due dates to the funding enterprise. It will also be appreciated that the business enterprise may remit funds to the funding party when the business enterprise receives payment from its customers.

This advantage also pertains to the first, third and fourth aspects of the present invention.

In the fifth aspect of the present invention, the contractual arrangements between the funding enterprise and the business enterprise may also include provisions for dealing with delinquent debts owed to the business enterprise.

Step (a) of the fifth aspect of the present invention may include any of the embodiments of step (a) as described with reference to the first, third or fourth aspect of the present invention.

Step (b) of the fifth aspect of the present invention may include any of the embodiments of step (b) as described with reference to the first, third or fourth aspects of the present invention.

In step (d), the money recovered from customers of the business enterprise is suitably money recovered from the accounts receivable due to the business enterprise or from the accounts receivable arising during the period.

In a sixth aspect, the present invention provides a method for providing funds from a funding enterprise to a business enterprise in which the business enterprise applies for the funds, the funding enterprise transfers the funds to the business enterprise and the business enterprise repays the funds to the funding enterprise, characterised in that the funding enterprise and business enterprise enter into a contractual agreement in which repayments are made by the business enterprise on specified dates or at specified time periods but the amount of the repayment is calculated by determining an amount of funds received by the business enterprise in payment of accounts by customers or clients of the business enterprise.

The contractual arrangements may require the business party to make repayments on a daily basis or as the funds are received from its customers.

Suitably, the contractual arrangements will also incorporate a final date for payment by the business enterprise to the funding enterprise of all outstanding payments, interest or charges due to the funding enterprise.

The contractual arrangements may also include a requirement to make one or more interim payments of interest or other charges due to the funding enterprise.

In a seventh aspect, the present invention provides a method for providing funds form a funding party to a business enterprise, the method including the steps of the business enterprise making application to the funding enterprise for the funds, the funding enterprise reviewing and approving the application for funds, the funding enterprise transferring the funds to the business enterprise, the business enterprise receiving payment for goods and/or services from its customers or clients, and the business enterprise making repayments to the funding enterprise based upon payments received by the business enterprise from its customers.

In the fifth, sixth and seventh aspects of the present invention, the step of recovering money from customers of the business enterprise or receiving payment for goods and/or services from customers or clients of the business enterprise may include one or more of the following:

a) the business enterprise receiving payments from the customers;

b) the funding enterprise providing a collection point system for receiving payment from the customers or clients of the business enterprise. This collection point system may operate similarly to a credit card system or an electronic payment system or an accounts recoverable system;

c) a third party receiving payments from the customers or clients of the business enterprise.

In some embodiments of the present invention, the funding party may advance the funds to the business enterprise and provide a collection mechanism for receiving payments from the customers of the business enterprise. The collection mechanisms may include any mechanism for receiving payment in respect of accounts receivable, including electronic transfers, mobile payment (via mobile device), over the counter payment, payment via the internet and the like. The collection mechanism and services may be directly provided by the funding party. Alternatively, the collection mechanism and collection services may be provided by a third party under contract to the funding party.

In other embodiments, the collection mechanisms may be provided by the business enterprise itself, or it may be provided by a third party under an arrangement between the third party and the business enterprise.

In embodiments where the funding party assumes responsibility for collection of accounts receivable (either directly or through the intermediary of a third party), provision of the collection mechanism and associated services can increase fees and margin for the funding party. The business enterprise also benefits from reduced back-office costs, which reduces all in costs of funds to the business enterprise.

The funding enterprise may, in some embodiments, be responsible for generating and issuing invoices on behalf of a business enterprise.

In the sixth and seventh aspect of the invention the business enterprise may use accounts receivable or estimated upcoming revenue or both as security for the funds transferred by the funding party.

The funding party may require the business enterprise to pay certain fees or charges in respect of the funds transferred. These fees or charges may include:

a) a requirement that the business enterprise repay a specified greater amount then the amount of funds transferred, e.g. $99 million may be transferred to the business enterprise but $100 million has to be paid back by the business enterprise to the funding enterprise;

b) a requirement that the business enterprise pay interest calculated on the basis of the amount of outstanding funds not paid back to the funding enterprise;

c) a requirement that the business enterprise pay any default or penalty payments levied on its customers for slow or late payment, to the funding party.

d) a requirement that the business enterprise pays a facility fee to the funding enterprise.

Other fees or charges may also apply.

The business enterprise may also be required to pay all outstanding funds, fees and charges to the funding enterprise at a specified time. This specified time will represent the term of the funding arrangement.

Unlike prior art funding arrangements in which the business enterprise is typically required to make payments of known amounts at specified times, the method of the sixth and seventh aspects of the present invention allow the funding party to make repayments that are calculated on the basis of payments received from customers or clients of the business enterprise. This allows for improved control over cash flow. The funding enterprise receives, in return, the fees and charges (and repayment of the transferred funds). Thus, the present invention provides an attractive financial solution to both the business enterprise and the funding party. The present invention provides a unique financial product never before provided by financial institutions. The present invention also allows the funding party (or second party) to provide a collections system in conjunction with the present invention, which may increase the financial return to the funding party and may also enable the business enterprise to lessen costs in its accounting department to thereby also increase profitability of the business enterprise.

The methods of all aspects of the present invention are suitably conducted using one or more computers.

The present invention also encompasses systems for operating the various methods of the third, fourth, fifth, sixth and seventh aspects of the present invention. The system is generally similar to the system described with reference to the second aspect of the present invention, albeit with appropriate modifications to account for variations between the first aspect of the present invention and the third, fourth and fifth aspects of the present invention.

In a further aspect of the present invention, the present inventors present a platform technology, particularly a computer-based platform technology, to facilitate implementation of the methods of the present invention.

Accordingly, in an eighth aspect, the present invention provides a platform for implementation on one or more computers, the platform comprising request means for a business enterprise to request funds from a funding party, information transfer means to transfer information relating to accounts receivable or anticipated future revenue for the business enterprise to the funding party, funds transfer means to transfer funds from the funding party to the business enterprise and payment tracking means to track payments made by customers or clients of the business enterprise.

The request means allows the business enterprise to request funds from the funding party. The request means is suitably enabled so that the business enterprise can access the request means following a period of negotiation between the funding party and the business enterprise and completion of a contract between the funding party and the business enterprise that settles the terms upon which the funds are to be transferred. These terms may include:
provision of adequate information from the business enterprise in relation to their accounts receivable or their anticipated future revenue;
repayment dates (bearing in mind that the amount of the repayments under the methods of the invention may be related to the amount of payments made by customers of the business enterprise);
final date for completing repayment;
provision for adequate tracking of payments made by customers of the business enterprise;
collection mechanisms for collecting payments from customers of the business enterprise, e.g. which party collects the payments, how are the payments collected;

The request means may be loaded onto one or more computers operated by or on behalf of the funding party. The request means may be accessed from one or more computers operated by or on behalf of the business enterprise. For example, the request means may be loaded onto a computer or computer network operated by the funding party. Once the request means is enabled for a particular business enterprise, the business enterprise may access the request means from a computer or computer network operated by the business enterprise. Suitably, the business enterprise can access the request means via the internet, although it will be appreciated that other modes of access may be provided, such as direct dial contact to the request means or even establishment of a dedicated connection line or cable. The request means may be accessed by allowing the business enterprise to have direct access to the request means or by providing a suitable interface that allows the business enterprise to enter the appropriate information to make the request, whereafter the interface transfers the information to the request means.

In order to validate a request for funds made by the business enterprise, the business enterprise will typically be required to provide information in relation to its accounts receivable or its anticipated future revenue. This information will need to be transferred to the funding party. The information transfer means may be as simple as a reader for reading recorded media that contains the information provided by the business enterprise (examples include floppy disc drives, CD ROM drives and DVD-drives) or data input means that allow information provided by the business enterprise. More suitably, the information transfer means transfers the information electronically from the business enterprise to the funding enterprise, for example, by an appreciate telecommunications link, by a computer cable link, via a computer network link or via the internet.

In some embodiments, the transfer of this information from the business enterprise to the funding party may be deemed to constitute a request for funds by the business enterprise. Thus, the information transfer means may incorporate the request means.

Once the request and the information have been received by the funding party, the funding party makes the decision as to whether or not they approve the request. Suitably, the platform includes decision making software to facilitate the making of this decision. The decision making software may include appropriate algorithms to analyse the request and the information provided by the business enterprise, to access the appropriate contractual provisions between the parties and to determine if the request falls within one or both of the internal funding criteria of the funding party and the contractual arrangements between the funding party and the business enterprise.

If and when the request is approved, the funding party transfers the funds to the business enterprise. The transfer of funds is suitably an electronic transfer of funds or establishment of a line of credit that can be accessed by the business enterprise as required. The funds transfer means may be provided by a third party, such as a bank.

When the funds are transferred, the funding party suitably also sends a notification to the business enterprise confirming that the transfer of funds has taken place. The notification may also include information relating to the relevant terms attached to the transfer of funds, such as reminders of payment due dates, and the date of any required final payment. The notification is suitably automatically generated by the platform software.

The contractual arrangements entered into between the funding party and the business enterprise will require that payments made by customers of the business enterprise, most typically payment of bills by the customers, be ultimately returned to the funding party. This may occur in a number of ways:
the customers pay the business enterprise, which subsequently remits the payments to the funding party,
the customers pay directly to the funding party;
the customers pay to a third party which remits the payments to the business enterprise which, in turn, remits the payments to the funding party;
the customers pay to a third party which remits the payments directly to the funding party.

In any case, it is necessary to track the payments so that paid accounts can be so-marked and unpaid accounts can be followed up as required (for example, by assessing penalty payments against unpaid or late-paid accounts, by sending payment reminders, by actively seeking payment of the unpaid accounts, etc.). The payment tracking means may form part of the accounting software of the business enterprise and this may interact with software in the platform and operating at or on a computer or network of the funding party. The software may be mirroring software so that appropriate accounts software at the end of the funding party mirrors the accounting details in respect of payments made by customers of the business enterprise, whether those accounting details are provided from the business enterprise or a third party.

Alternatively, the payment tracking software may comprise accounting software operated by the funding party. This is particularly useful in cases where the funding party collects payments directly.

The payment tracking means of the platform may not necessarily have to track each individual payment. The payment tracking means may track a running total of payments made so that the funding party can track the total level of payments (which equates to the total funds due to be paid to the funding party by the business enterprise). Details of individual unpaid accounts may then be transferred to the funding party.

It is preferred that the funding party operate its own payment tracking software so that checking of unpaid accounts and assessment of penalty payments can be independently verified by the funding party and so that such assessment can occur in a timely fashion.

Throughout this specification, the terms “first party” and “business enterprise” may be used interchangeably. Similarly, the terms “second party” and “funding party” may be used interchangeably.

In this specification, the term “business enterprise” is to be given a broad meaning that encompasses both for-profit and not-for-profit organisations, charities, religious organisations, profitable businesses and businesses running at a loss.

Preferred embodiments of the invention will now be described with reference to the following drawings. It is to be understood that the drawings are provided for the purposes of illustrating the preferred embodiments of the present invention and the invention should not be considered to be limited to the features shown in the drawings.

### BRIEF DESCRIPTION OF THE DRAWINGS

FIG. 1 shows a flow sheet of one embodiment of the present invention;

FIG. 2 shows a flow sheet of another embodiment of the present invention;

FIG. 3 shows a flow sheet of a third embodiment of the present invention;

FIG. 4 shows a schematic diagram of a system in accordance with an embodiment of the present invention.

FIG. 5 is a flow sheet showing an embodiment of the present invention;

FIG. 6 is a flow sheet showing another embodiment of the present invention;

FIG. 7 is a flow sheet showing further embodiment of the present invention;

FIG. 8 is a flow sheet showing a further still embodiment of the present invention;

FIG. 9 is a flow sheet showing yet another embodiment of the present invention;

FIG. 10 is a flow sheet showing another embodiment of the present invention;

FIG. 11 is flow sheet showing a still further embodiment of the present invention;

FIG. 12 is a flow sheet showing another embodiment of the present invention;

FIG. 13 is a flow sheet showing another embodiment of the present invention;

FIG. 14 shows a flow sheet of an embodiment of the present invention that relates to the business enterprise making a request for funds from the funding party;

FIG. 15 shows a flow sheet of an embodiment of the present invention relating to payment of customers accounts, with payments from customers being received by the business enterprise;

FIG. 16 shows a flow sheet of an embodiment of the present invention outlining how non-payment or late payment of an account by a customer of a business enterprise might be handled;

FIG. 17 shows a flow sheet of another embodiment of the present invention outlining an alternative way of handling non-payment or late payment of an account by a customer of the business enterprise;

FIG. 18 shows a flow sheet of an embodiment of the present invention relating to payment of an account by a customer of the business enterprise, with the payment being received directly by the funding party;

FIG. 19 shows a flow sheet outlining an embodiment of the present invention relating to non-payment or late payment of accounts under the payment arrangements shown in FIG. 18;

FIG. 20 shows a flow sheet of an embodiment of the present invention in which the funding party issues invoices on behalf of the business enterprise;

FIG. 21 shows a flow sheet outlining an embodiment of the present invention relating to non-payment or late payment of accounts in circumstances where the funding party is responsible for collection of payments;

FIG. 22 is a flow sheet showing more detail of an embodiment for transferring funds to the business enterprise; and

FIG. 23 shows a flow sheet of an embodiment of the present invention outlining payments made by the funding party to the bank at the end of each month.

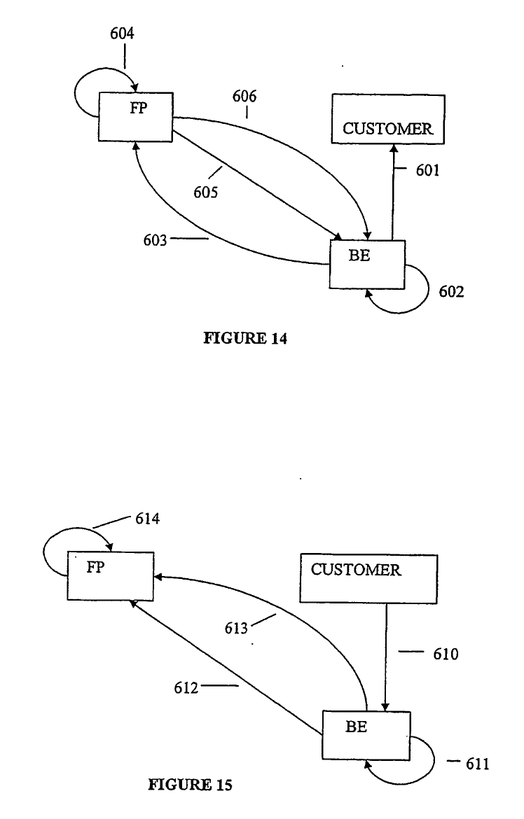

It will be understood that the embodiments of FIGS. 14 to 23 each show a flow sheet of various embodiments of parts of the overall invention.

### DETAILED DESCRIPTION OF THE DRAWINGS

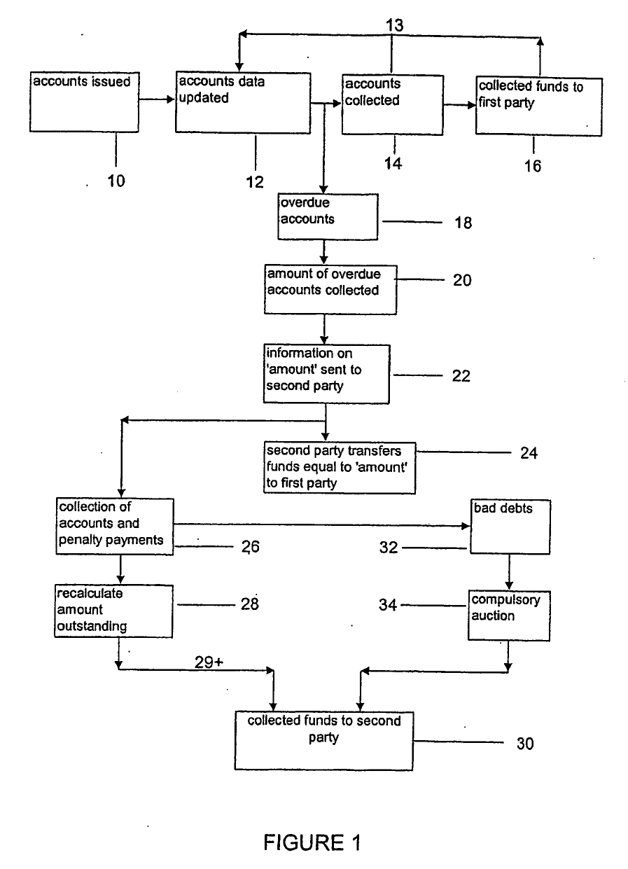

FIG. 1 shows a flow sheet of one embodiment of the present invention. In FIG. 1, the first party issues accounts at step 10. When the accounts are issued at step 10, the accounts data is updated at step 12. This step typically involves updating an accounts receivable ledger. The updating of the accounts receivable ledger at step 12 may involve an automatic transfer of data from an accounts generation program into the accounts receivable ledger. Alternatively, information relating to the accounts issued may be manually entered into the accounts receivable data by one or more data input operators.

In the embodiment shown in FIG. 1, the first party retains responsibility for collecting payment of all debts that fall due within normal trading terms. Throughout this specification, the term “normal trading terms” is taken to mean payment of an account within a time specified by the first party and typically mentioned on the account. Some examples of normal trading terms may be seven days from the date of the account, 14 days from the date of the account or 30 days from the date of the account.

In the flow sheet shown in FIG. 1 the first party collects all funds arriving from payment of accounts within normal trading terms. This is shown in step 14. Step 16 diagrammatically shows that the collected funds from accounts paid within normal trading terms are provided to the first party. It will be appreciated that when an account is paid within normal trading terms that the accounts data is updated to reflect payment of a particular account. This is schematically shown by arrow 13 in FIG. 1.

Once the time for normal trading terms has expired, the accounts become overdue. In the method shown in FIG. 1, the overdue accounts 18, are flagged or otherwise noted and the total amount of monies owing due to the overdue accounts is calculated at step 20. Information relating to the amount is then sent to the second party at step 22. It will be appreciated that the information on the amount that is sent to the second party will include the total amount of overdue accounts, information relating to penalty payments arising due to late payment of the overdue amounts and also information on each account that is included in the overdue accounts.

Once the second party receives information on the amount arising from the total overdue accounts, the second party then transfers funds equal to the amount to the first party. This is schematically shown at step 24. It will be appreciated that the total funds transferred from the second party to first party at step 24 is the total amount of outstanding accounts, calculated exclusive of any penalty payments. In other words, the amount calculated in step 20, which is equal to the amount of funds remitted by the second party to the first party in step 24, is equivalent to the face value shown on the accounts for all overdue accounts.

Collection of the overdue accounts involves collecting the amount shown on the face of the account and collecting penalty payments that arise by virtue of late payment of the accounts. In this regard, it will be understood that the total amount collected in payment of the overdue accounts will be greater than the amount calculated at step 20 by virtue of collection of the overdue accounts collecting the face value of the accounts and penalty payments.

Once collection of the overdue accounts and penalty payments has taken place at step 26, the amount outstanding is recalculated at 28 to reflect the payments received. Arrow 27 shows that collection of accounts and recalculation of the amount outstanding of the overdue accounts is an ongoing process.

Once payment of the outstanding account has been received, the funds collected from payments of the outstanding accounts, which include penalty payments are then remitted via step 29 to the second party at 30.

For bad debts 32 where payment is not received, advantage may be taken of any security to recover the bad debts. In the embodiment shown in FIG. 1 which relates specifically to accounts that are raised by a local council for payment of rates, the applicable state government provides for compulsory auction of land to which the rate notice applies. Therefore, bad debts 32 can trigger a compulsory auction 34 in order to recover the outstanding account and the penalty payments. The funds collected as a result are then transferred via step 35 to the second party 30. Alternatively, bad debts may be charged back to the first party, suitably with a nominal fee, or insurance to cover for bad debts may be taken out by either the first party or the second party.

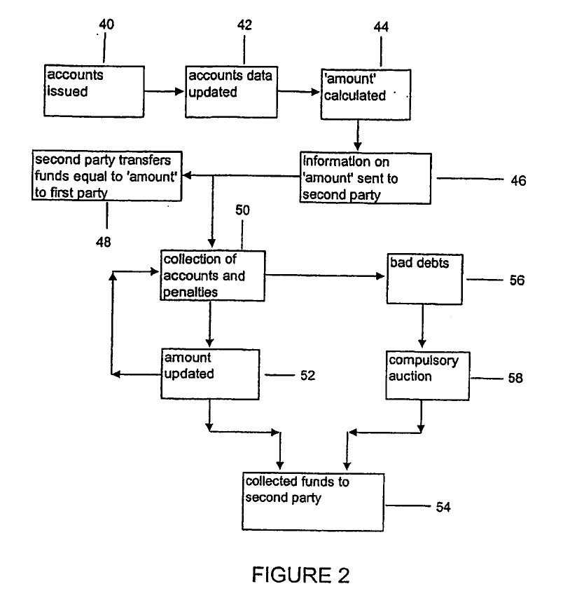

FIG. 2 shows a flow sheet of another embodiment of the present invention In FIG. 2, accounts are issued at step 40 and the accounts data is updated at 42. Steps 40 and 42 are essentially identical to steps 10 and 12 as described with reference to FIG. 1.

Once the accounts data has been updated at step 42, the amount of funds owing due to all outstanding accounts is calculated. This is shown at step 44. In step 44 the total outstanding accounts, including current accounts and outstanding accounts, are calculated to calculate the amount. Information on the amount is then sent to the second party as shown at step 46. Once the second party receives information on the amount, the second party transfers funds equal to the amount to the first party at step 48. Collection of the accounts and penalties then follows at 50. When an account is collected, the amount is updated and the accounts receivable ledger is also updated at 52 to reflect payment of the account. In the embodiment shown in FIG. 2 all collected funds are provided to the second party at 54. For bad accounts 56 a compulsory auction 58 is held and funds recovered equal to the amount of the account and outstanding penalty payments are provided via step 59 to the second party 54.

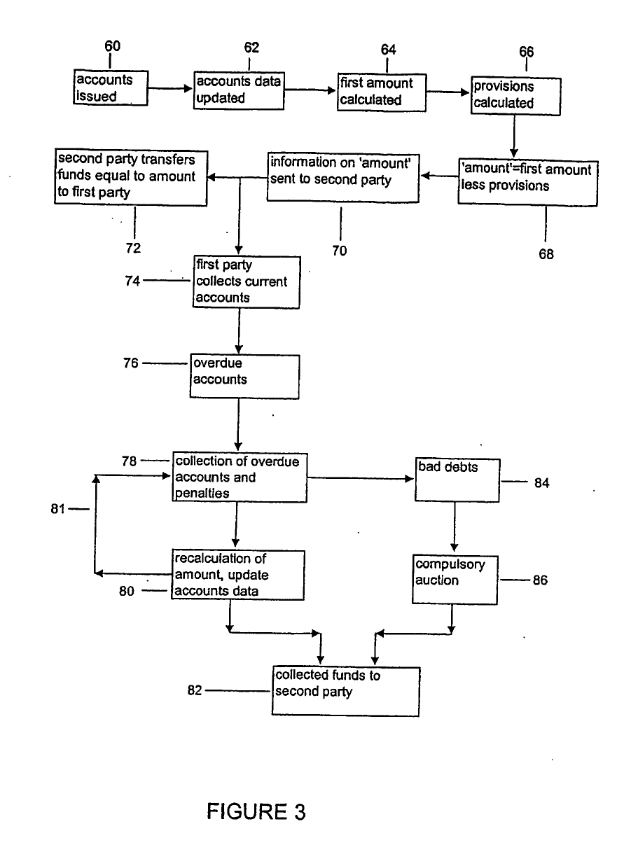

FIG. 3 shows a flow sheet of a further embodiment of the present invention. In FIG. 3, the first party issues accounts at 60 and the accounts data is updated at step 62. Step 60 and 62 of FIG. 3 are identical to steps 10 and 12 as described with reference to FIG. 1. Once the accounts have issue in the embodiment shown in FIG. 3 a first amount is calculated at step 64. The first amount is the total of all outstanding accounts owing to the first party. Various provisions may then be calculated at step 66. The provisions may include an estimated amount arising from on-time or early payment of the issued accounts and a further provision for any discounts applied to early or on-time payments by the first party. Once the provisions have been calculated, the amount is then determined at 68 by taking the first amount and subtracting the provisions therefrom Information on the amount is then sent to the second party at step 70. Step 70 is identical to step 22 as described with reference to FIG. 1.

Once the second party has received information on the amount to the first party (step 72), the second party transfers funds equal to the amount to the first party.

In the embodiment shown in FIG. 3 the first party collects current accounts at 74. It is to be understood that the current accounts consist of all accounts that are paid within normal trading terms of the first party.

After expiration of the normal trading terms, unpaid accounts become overdue accounts 76. Collection of the overdue accounts involves collecting the face value of the accounts and the penalty payments specified on the accounts or in the credit contract between the first party and its creditors. Once the overdue accounts and penalty payments have been collected the amount outstanding is recalculated and the relevant accounts data updated at 80. Arrow 81 indicates that this is an ongoing process as collection of the overdue accounts occurs. The collected funds relating to the collection of the overdue accounts which include collected penalty payments are sent to the second party at 82.

For bad debts 84 a compulsory auction 86 may be held and all funds owing for payment of the bad debt and penalty payments are sent via step 87 to the second party.

To provide examples of how the flow sheets shown in FIGS. 1 to 3 would operate, the following hypothetical example is provided. A local council issues quarterly rate notices totalling $1 million per quarter. Historically, 95% of these rates notices are paid within normal trading terms being 30 days from the date of invoice. A 5% discount is given by the council for early or on-time payment. Therefore, if all rate invoices were paid on time the council would collect $0.95 million per quarter in full payment of those rate invoices. The council levies penalty interest at 10% per annum for late payment. Penalty interest commences as soon as normal trading terms are exceeded. For the purposes of this example, it is assumed that overdue accounts attract two months penalty interest in each quarter.

For the flow sheet shown in FIG. 1, the following information obtains:
Quarterly invoices equal $1 million.
Total overdue invoices per quarter equals $50,000 (5% of overall total)
Penalty interest equals 10% per annum of $50,000 total overdue for two months equals $833.33 per quarter.

In the embodiment shown in FIG. 1, the amount calculated at step 20 is 50,000. The funds transferred to the first party at step 24 totals $50,000. The funds recovered by the second party at 30 totals $50,833. Therefore, the profit to the second party equals $833 per quarter. It will be appreciated that this figure is calculated without taking into account the cost of the funds to the second party.

For the embodiment shown in FIG. 2, the amount calculated at step 44 is $1 million. Of this, $0.95 million is recovered by the second party within one month and $50833 is recovered from the overdue accounts. Thus the second party recovers $1.00083 million, leaving a profit of $833.33 per quarter. However, if the second party requires funding to transfer the funds to the first party, then the cost of funds to the second party will be significant due to the fact that the entire amount of outstanding invoices is transferred to the first party as soon as the invoices are generated. Thus, the flow sheet of FIG. 2 may not be a preferred flow sheet.

In the flow sheet of FIG. 3, the first amount calculated at step 64 is $1 million. Provision 1 is calculated at step 66 as being $0.95 million, this being the amount of total accounts that are expected to be paid within normal trading terms. Provision 2 is calculated as being 5% of the $50,000 for overdue accounts. This amount, being $2,500, is calculated as the discount applied by the council to the overdue accounts if those accounts were paid on time.

The amount calculated in step 68 of FIG. 3 is therefore $1 million minus $0.95 million minus $2,500 equals $47,500 dollars. This amount is received by council before 30 days from the issue of the quarterly rates invoices and most preferably within one or two days from the date of issue of the quarterly rates invoices. Therefore, within 30 days of the issue of the rates invoices, the council collects $0.95 million in total, being $0.9025 million in collections ($0.95 million worth of accounts paid on time less the 5% discount allowed for on time payment) and $47,500 from the second party. Effectively, the council has received full payment of the book value of its rates invoices within 30 days of the issue of those accounts.

The second party has transferred $47,500 to the council before 30 days. As shown above, the second party collects $50,833 on the overdue accounts and penalty interest payments. Therefore, the profit to the second company totals $3,333 per quarter.

Assuming that the second company has to borrow to fund its transfer of funds to the council, and that the second party pays interest of 6% on its funds, assuming full collection by the second party within two months of transferring funds to the council, the second party has to pay interest of $975 on its funds transferred to the first party. This leaves a profit of $2,358 per quarter to the second party.

The quid pro quo for the council arises from the improved cash flow received by the council. This provides immediate funds for the councils growth, enables the council to concentrate on its core business and in turn to achieve greater efficiencies, enables the council to take advantage of discounts offered by suppliers, overcomes any short term or seasonal cash flow problems, reduces debt collection activity and can result in a significant reduction in accounts receivable staff costs, and provides more monies to use as leverage for funding (either grants or project related) from state and federal government.

It is noted in the above examples that the second party may also incur some further costs in collecting the overdue accounts.

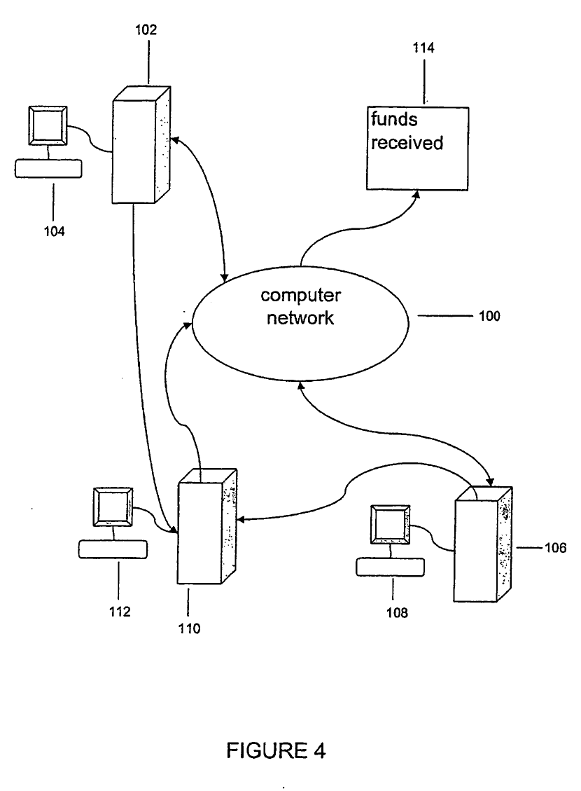

FIG. 4 shows some schematic diagrams of systems that can be used to operate the method of the present invention.

FIG. 4 shows a computer network 100 that may be a wide area network, a local area network, or even the internet. The first party has a computer 102 having data entry means in the form of a keyboard and monitor 104 attached thereto. Computer 102 of the first party is connected to the computer network 100. Computer 102 may be used to generate invoices and to input data into the accounts receivable ledger. Computer 102 may carry an accounting program as operated by the first party in order to track accounts receivable and to determine when accounts fall overdue by failure to achieve payment within normal trading terms.

The system shown in FIG. 4 also includes a computer 106 of the second party having associated keyboard and monitor 108. As can be seen from FIG. 4, computer 106 is also connected to computer network 100. Computer 106 is also connected to a computer 110 owned by a financial institution, such as a bank, building society or credit union. Computer 110 includes keyboard and monitor 112. In operation of the system shown in FIG. 4 to operate the method as described with reference to FIG. 1, 2 or 3, computer 102 of the first party is used to calculate the amount. This information is then supplied from computer 102 via computer network 100 to the computer 106 of the second party. Upon receiving that information, computer 106 sends a request to computer 110 of financial institution requesting that any electronic transfer of funds equivalent to the amount sent from computer 102 to computer 106 be transferred from a credit facility operated by the second party with the financial institution to an account operated by a first party. In response to that request, computer 110 instructs an electronic fund transfer to take place via computer network 100 so that funds are received in account 114 operated by the first party.

When accounts are paid and payments received by the second party, computer 106 updates the accounts receivable information to indicate that the particular account has been paid. Payment of the account may also initiate a transfer of funds into the credit facility operated by the financial institution in order to reduce the principle outstanding on that credit facility.

The present invention may be subject to a number of variations and modifications. In particular, collection of the accounts may be the responsibility of the first party, in which case funds collected by the first party will have to be transferred to the second party. Alternatively, the second party may assume responsibility for collection of outstanding accounts. This is preferred from the viewpoint of the first party as the benefits arising from reduced costs and administrative burden in the accounting section of the first party accrue when the second party is responsible for collection of outstanding debts. Further efficiencies are obtained by obviating the necessity of transferring funds of from the first party to the second party. In a further alternative, a third party, such as a debt collection agency, may be used to collect the outstanding accounts, with the third party remitting collected monies to the second party. It would be expected that the third party would charge either a fee for service or a percentage of accounts collected for its services in collecting the outstanding accounts.

The system described in FIG. 4 may also be subject to a number of modifications. Preferred systems all result in the amount being calculated and information on the amount and the accounts receivable being sent to the second party to enable funds transfer to occur. Preferred systems also update the accounts data to monitor payment of accounts.

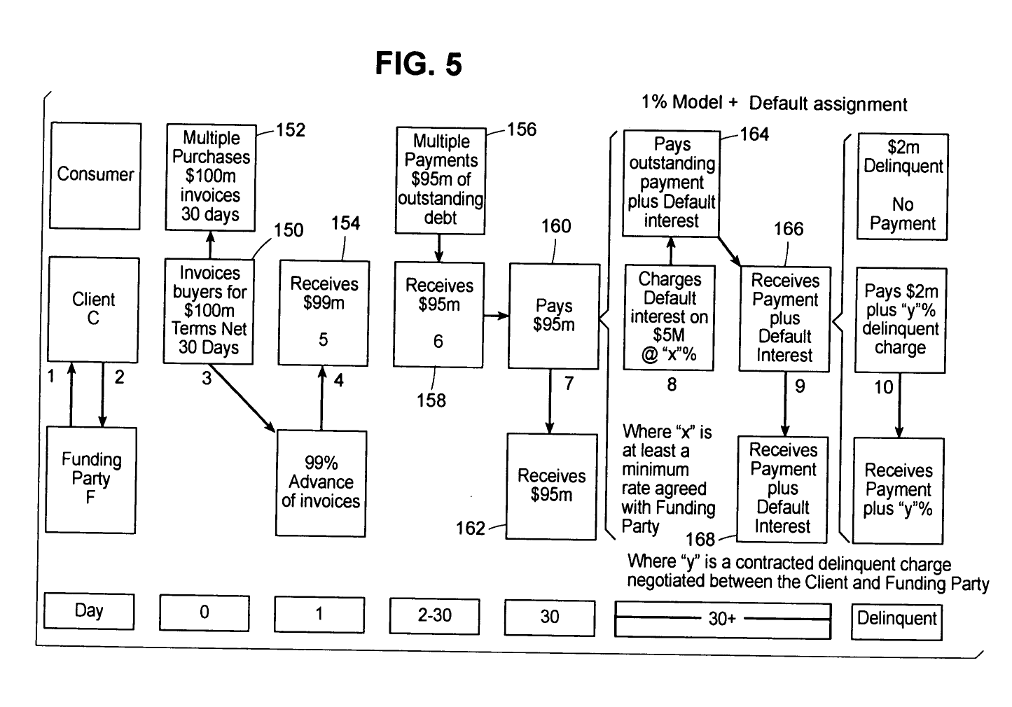

In FIGS. 5 to 12 and the associated description, the term “client” is used to refer to the business enterprise (or first party) that issues accounts to consumers. In this regard, the business enterprise (or first party) is a client of the funding party.

Turning now to FIG. 5, which shows a flow sheet of an embodiment of the present invention, in FIG. 5, the client is represented by box C and all further boxes on line C relate to actions pertaining to the client. The consumer, who is a user of the products or services of client C (for example, by purchasing product or services from client C) is represented by all boxes on line D. The funding party, which corresponds to the second party, is represented by the boxes on line F.

In order to establish the relationship between client C and funding party F, the funding party F consults with client C (shown by arrow 1) or client C consults with funding body F (as shown by arrow 2). The client C and the funding party F agree to the terms of their relationship and sign appropriate contract documents.

At box 150, the client C issues invoices to purchases made by multiple buyers for, say, one hundred million dollars. The invoices are forwarded to the consumer D at box 152. The client C advises the funding party F that the invoices totalling one hundred million dollars have been invoiced (as shown by arrow 3). This occurs at day 0, being the day at which the invoices were invoiced. At day 1 the funding party F remits 99 million dollars to the client C. The 99 million dollars is calculated in accordance with the contract between the client C and the funding party F which specifies, in this example, that the funding party F remits 99% of the total value of invoices aggregated in box 150. Thus, the client C receives 99 million dollars at box 154. These funds are received one day after generation of the invoices. In practice, the invoices generated in box 150 are suitably uploaded to the funding party F via an appropriate web portal using appropriate data transfer, interface and security protocols. Once the funding party F receives the details of the uploaded invoices, an appropriate manager authorise the transfer of the appropriate amount of funds to the clients' account. This is received in box 154.

Upon receiving the 99 million dollars on day 1, the client C is free to use that money as it sees fit. It may be used as operating cash flow, thereby obviating the need to obtain cash flow from other funding sources, such as a short term credit facility, overdraft, bank bills or the like.

Under the contractual arrangements existing between the funding party F and the client C in the flow sheet shown in FIG. 5, the client C only needs to make its first repayment 30 days after generation of the invoices. As shown in FIG. 5, from day 2 to 30 after generation of the invoices, the consumers D start to pay the outstanding invoices from days 2 to 30. For example, at box 156, the consumers D may make payments totalling 95 million dollars to the client C, which payments are received at box 158. At this stage, the client has received 99 million dollars from the funding party F at day 1 and a further 95 million dollars from its customers (consumer D) from days 2 to 30. Thus, the client has the benefit of the 99 million dollars received from the funding party and the 95 million dollars received from the payments made by its consumers. The client can use the additional funds to generate further funds, for example, by investing in short term securities.

Under the funding arrangements between client C and funding party F, on day 30, the client C pays all of the funds it has recovered from its consumers at that date. This is represented by box 160. Thus, on day 30, the client C transfers the funds recovered from consumers D to the funding party F, as shown at box 162.

Any invoices remaining unpaid after day 30 are overdue invoices. Under the purchase agreement between the consumer D and the client C, these invoices are overdue invoices and penalty interest is payable. For the purposes of the example shown in FIG. 5, it is assumed that, of the five million dollars of the original invoices still outstanding, three million dollars will be paid as late payment by consumers D. The remaining two million dollars worth of invoices will be assumed, for the purposes of this example, to represent bad debts or delinquent debts.

For the period represented for 30+ days in FIG. 5, the client C charges default interest on three million dollars at the agreed default interest rate. This is shown in box 58. The consumer D who pays the late payments pays the outstanding payment plus the default interest rate, as schematically shown at box 164. The client C receives payments of the three million dollars plus the agreed penalty interest rate on the three million dollars at box 166 and those payments are paid to the funding party F at box 168. It will be appreciated that the payments made at box 168 may be made at an agreed final date (for example, 150 days after the date of the invoice, with any invoices not paid after the agreed final date being considered to be delinquent or bad debts. Alternatively, the payments made to the funding party F at box 168 may represent a series of payments made at defined time periods, for example, 60 days, 90 days and 120 days after day 0. The payments made at each of these defined periods represent the total amount of payments plus default interest received from consumers D since the previous payment.

With regard to the delinquent payments (which effectively are bad debts), the delinquent debts may be handled by a number of different arrangements between the funding party F and the client C. In the example shown in FIG. 5, the contractual arrangements between the client C and the funding party F provide that the client C will repay any delinquent debts plus an appropriate delinquent charge (which will typically be a percentage of the delinquent debt). For example, the funding party F charges Y percent on the delinquent amount. This amount is charged to the client C who then pays the delinquent debt (arrow 10) plus the delinquent charge to the funding party.

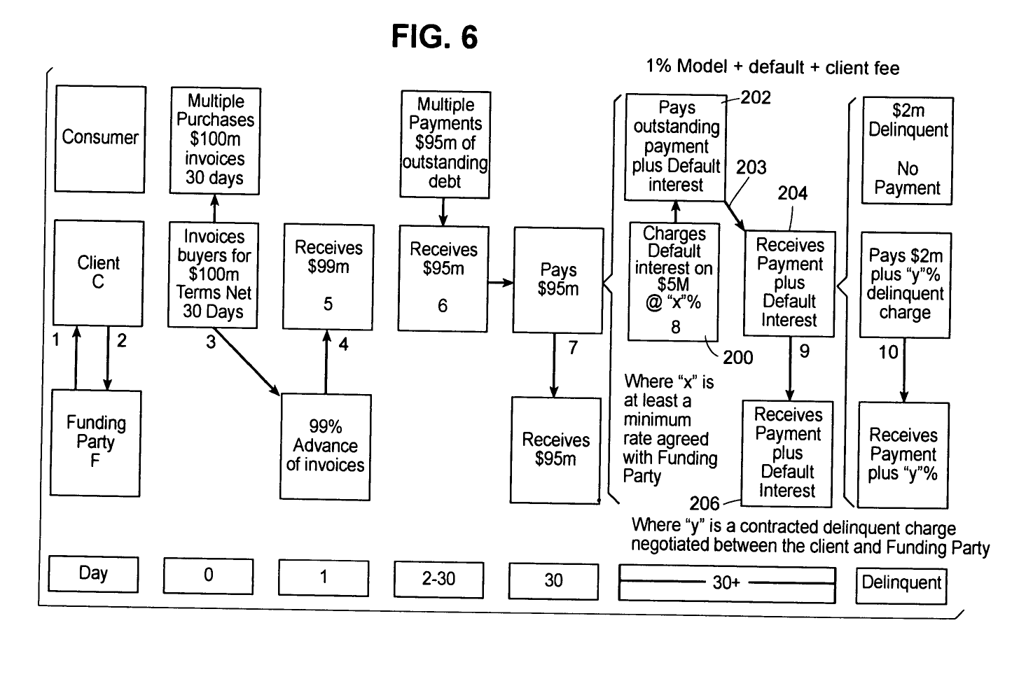

FIG. 6 is a flow sheet showing another embodiment of the present invention. In the flow sheet shown in FIG. 6, the method for days 0 to 30 is the same as for that shown in FIG. 5 and further description need not be given Similarly, the method in FIG. 6 for the delinquent period is the same as that foreshown in FIG. 5. For this reason, further description of the delinquent period in FIG. 6 need not be given.

The embodiment shown in FIG. 6 differs from that in FIG. 5 in that the late payments attract a default interest plus a client fee. Thus, at box 200 the client C applies default charges at the agreed default interest rate between the client C and consumer D, as well as a client fee. These charges are charged to the late paid invoices 2002. The consumer D makes the appropriate payments of the late invoices, including the amount of the invoice, the default interest rate and the client fee via transfer of money 203 which is subsequently received by the client at box 204. The client subsequently pays the invoice amount plus the default interest to funding party F at 206. In this embodiment, the client is entitled to retain the client fee on late payments.

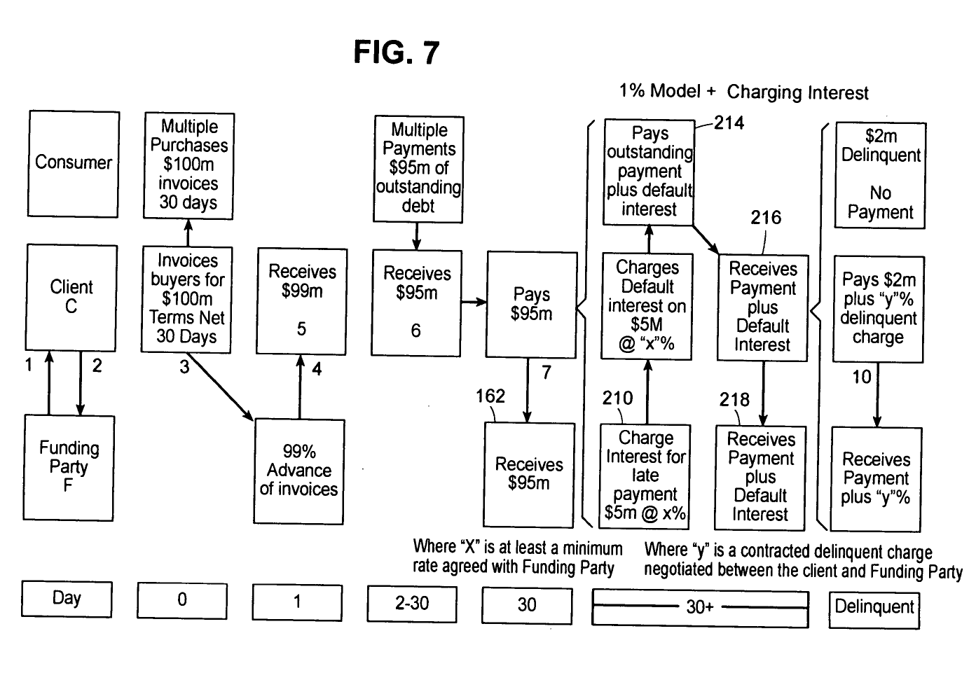

FIG. 7 is a flow sheet showing a further embodiment of the preset invention. In FIG. 7, the method from day 0 to day 30 is essentially the same as that shown in FIG. 5 and need not be described further. Similarly, the method shown in FIG. 7 for the delinquent period is essentially the same as the method shown in FIG. 5 for the delinquent period. Hence, the delinquent period portion of the method shown in FIG. 7 need not be described further.

In FIG. 7, the treatment of late payment invoices differs from that shown in FIG. 5. In the method shown in FIG. 7, the contractual arrangements between the funding party F and the client C allow the funding party F to charge interest on the late payments. For example, in the embodiment shown in FIG. 7, the client C repays the collected 95 million dollars at 30 days, as shown by reference to box 162. Although the funding party F only forwarded 99 million dollars at day 0 to the client C, the client C, under the terms of their contractual agreement, effectively must repay a principal of 100 million dollars in total to the funding party F. Thus, the interest charged due to funding party F as a result of the late payment is the interest calculated on an outstanding amount of five million dollars. Thus, funding party F calculates the interest outstanding at box 210. The client C charges the consumer D interest on the late payment invoices (totalling five million dollars) at the agreed default interest rate (agreed between the client C and consumer D). The consumer D pays the late payment plus appropriate default interest at box 214, which late payment plus appropriate default interest is received by the client C. The client C subsequently forwards the payment to the funding party F at 218. It will be appreciated that the amount paid to the funding party F at box 218 equals the amount calculated at box 210.

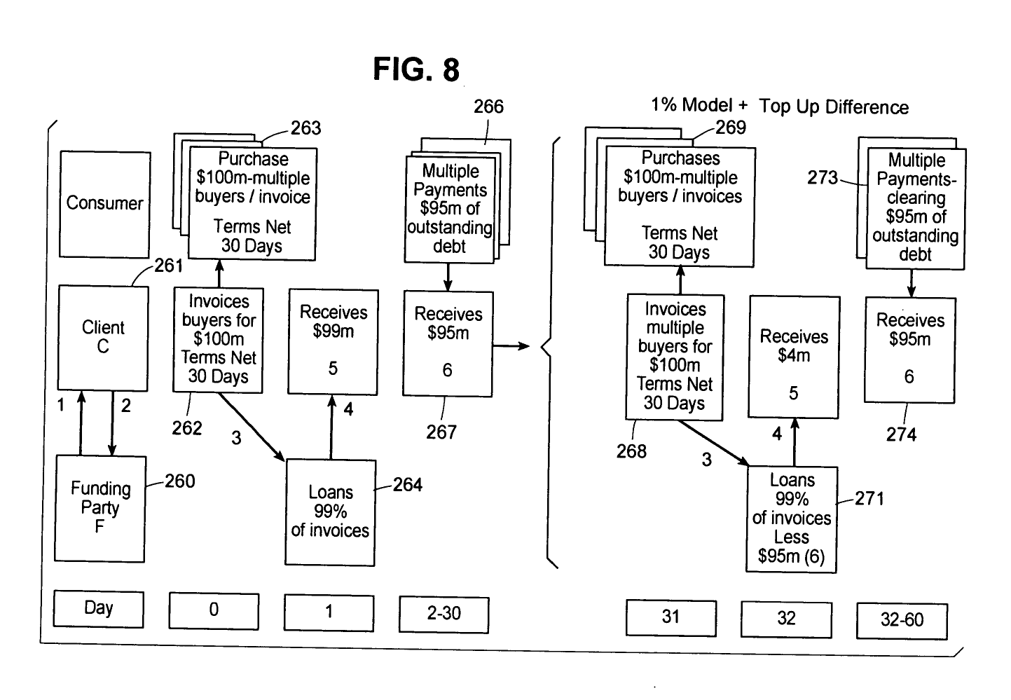

FIG. 8 shows a further flow sheet in accordance with another embodiment of the present invention. In FIG. 8, the funding party F and business enterprise C negotiate an appropriate funding arrangement, at 260 and 261. At day 0, the business enterprise C issues (at 262) multiple invoices to multiple buyers for $100 million with a term of 30 days net. These invoices are passed at 263 to the multiple buyers or consumers D. At the same time, the business enterprise C advises the funding party F of the issue of the invoices. At 264, the funding party F receives notice of the $100 million in invoices and, in accordance with the contractual arrangements between the funding party F and business enterprise C, loans 99% of the invoices to the business enterprise C (at step 264). Thus, at step 265, the business enterprise C receives $99 million. As shown in FIG. 8, business enterprise C receives the $99 million at day 1 (being 1 day after issue of the invoices).

At days 2 to 30, the consumers D pay a proportion of the outstanding invoices. For example, at 266, the consumers D make multiple payments which pay off $95 million of the total invoices. This $95 million is received at 267 by the funding party C.

After 30 days, at day 31, the business enterprise C, at step 268, processes a further run of invoices. At sep 268, the total of the new invoices is $100 million. These invoices are issued to multiple buyers. The invoices totalling $100 million are issued, at step 269, to the consumers D. The business enterprise C also advises the funding enterprise F of the issue of the $100 million in new invoices, as shown by second arrow 3. The funding party, at 271, in accordance with the contractual relations between the funding party F and business enterprise C, determines that $99 million should be paid to the business enterprise C in respect of the $100 million worth of invoices issued at step 268. However, the business enterprise C has completed collection of $95 million for the previous day 2 to 30 period. Instead of the business enterprise C transferring that $95 million to the funding party F and then the funding party F transferring $99 million back to the business enterprise C, the business enterprise C, at step 271, transfers the difference ($99 million less $95 million=$4 million) to the business enterprise C. Thus, at 272, the business enterprise C receives $4 million from the funding party F. At this stage (day 32) the amount outstanding from business enterprise C to funding party F totals $105 million, being $100 million owing from the first transfer of money at 265 and $5 million owing from the second transfer of money at 272.

From days 32 to 60, the consumers D pay, say $95 million in respect of the outstanding $100 million worth of invoices from step 268. This is shown at step 273, with the business enterprise C receiving that $95 million at step 274.

The process then continues by repeating steps 268 to 274. Although not shown in FIG. 8, the flow sheet of FIG. 8 will also include the recovery of late payments from consumers D and the transfer of moneys, including payments and default penalty payments, from the business enterprise C to the funding party F.

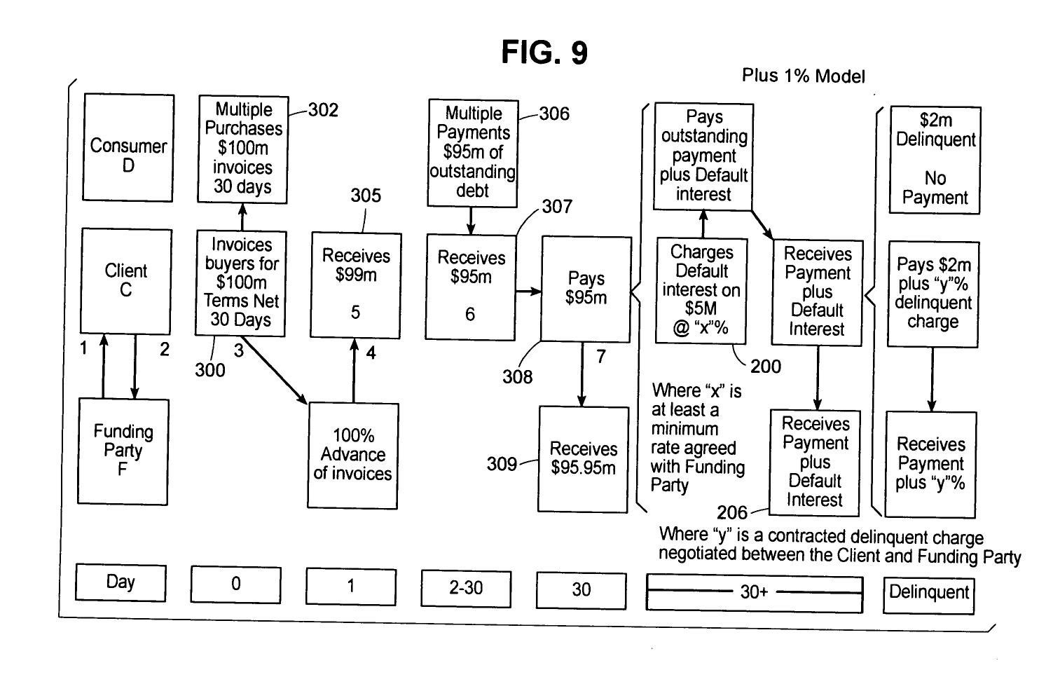

FIG. 9 shows a flow sheet of another embodiment of the present invention. In FIG. 9, the funding party F and the client C agree to mutually satisfactorily contractual terms.

At day 0, the client C issues multiple invoices totalling, say 100 million dollars, see box 300. The multiple invoices totalling 100 million dollars are forwarded to consumers D at box 302. The client C also forwards details of the multiple invoices issued at box 300 and sends details of those invoices to funding party F at box 304.

Upon receiving details of the invoices, at day 1, the funding party F transfers an amount equal to the amount of the total invoices to client C. Therefore, client C receives 100 million dollars, as shown by reference numeral 5. This money is received on Day 1, being one day after generation of the multiple invoices.

The consumers D commence paying the invoices, as shown by reference numeral 306 and the amounts are transferred at 307 to the client C. As can be seen from FIG. 9, these payments of the invoices, which represent payment within normal trading terms, are made in the period 2-30 days after generation of the invoices. Thus, at this stage, the client has received 100 million dollars from funding party F and is also receiving payments from consumers D. Effectively, the client C is “double dipping” in that it has effectively been paid twice at this stage for the bulk of its invoices. The additional funding arising as a result in the period 2-30 days after generation of the invoices can be used by the client C to generate extra income, for example by investing in short term money markets.

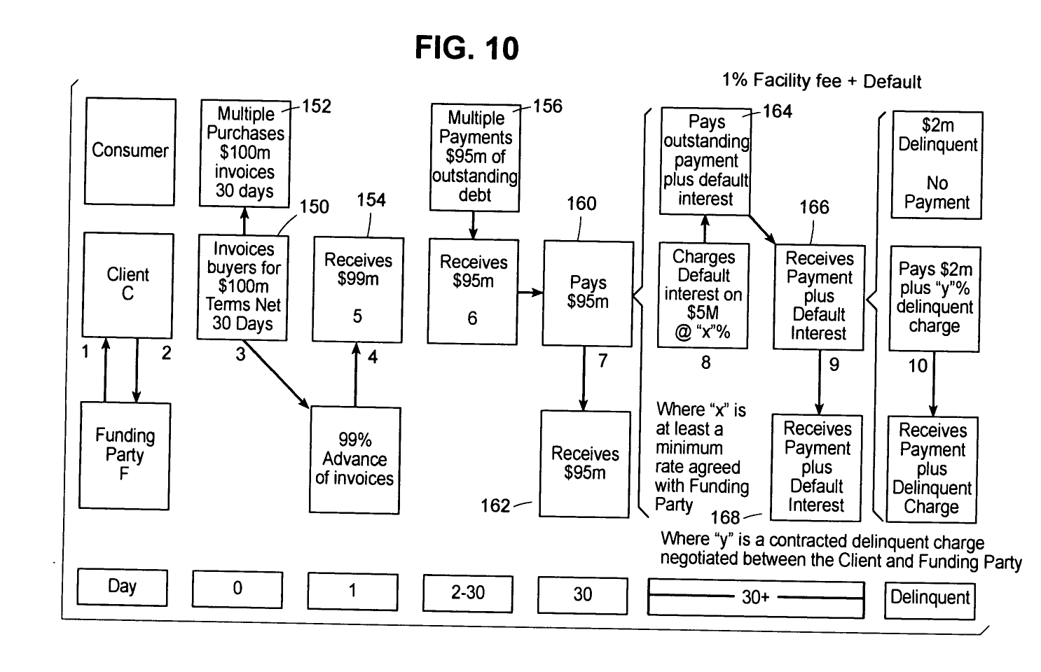

Under the contractual details, the client C is obligated to pay the funds collected from consumers D to the funding party F at day 30. Additionally, at day 30, the client C is further obligated under its contractual arrangements to pay an additional 1%, calculated on the basis of total funds collected on the invoices 300, to funding party F. Therefore, in the example shown in FIG. 9, 95 million dollars has been collected by client C from consumers D at 30 days. One percent of 95 million dollars equals 0.95 million dollars. Therefore, at 30 days, client C pays 95.95 million dollars to funding party F. This is shown at reference numeral 308 and reference numeral 309 in FIG. 10.

It will be appreciated that the amount paid by the client C to the funding party F at 308, 309 may vary in accordance with the particular contractual arrangements reached between client C and funding party F. For example, an interest rate other than 1% may be used.

In FIG. 9, late payments of invoices, as represented in the 30+ day period and delinquent invoices or bad debts, as indicated in the delinquent period, in FIG. 9, are handled in the same fashion as for the flow sheet shown in FIG. 5. Consequently, these need not be described further.

FIG. 10 shows a flow sheet that is essentially similar to that of FIG. 5, but rather than charging default interest (as shown in FIG. 5), a facility fee is charged.

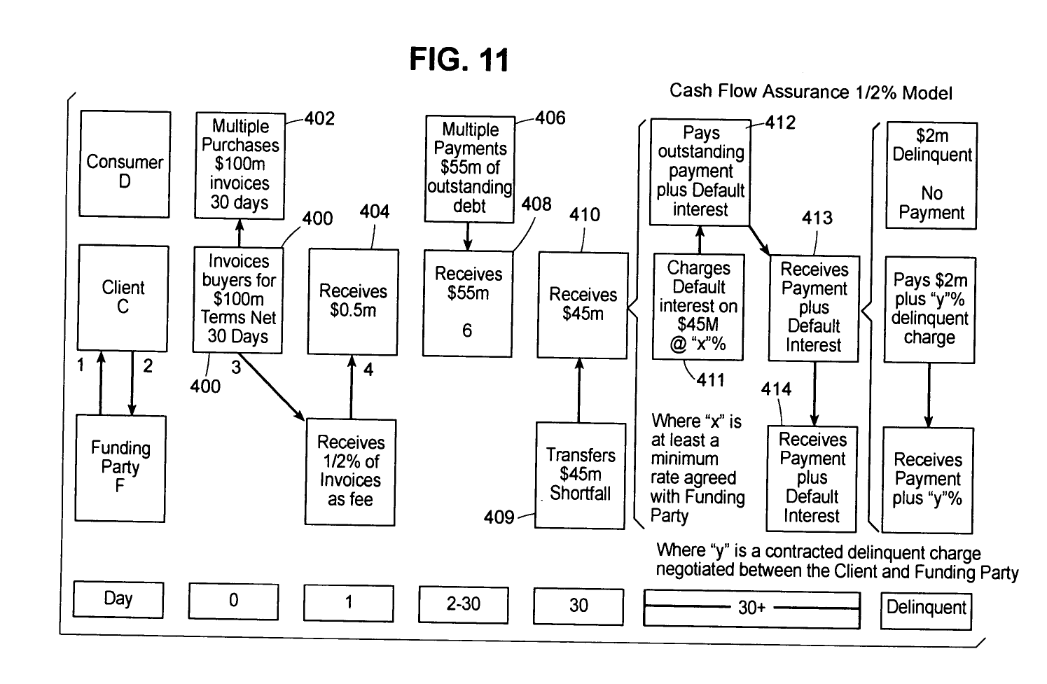

FIG. 11 shows a flow sheet of another embodiment of the present invention.

In FIG. 11, the client C generates multiple invoices totalling 100 million dollars on day 0. These invoices are generated on the basis of terms of net 30 days. This is shown by reference numeral 400. The invoices generated at 400 are provided to consumers D at reference numeral 402.

The client C also provides relevant data relating to the multiple invoices shown at 400 to the funding party F. This information may be provided by the client C uploading details of the invoices through a web portal operated by the funding party F and using appropriate data transfer and security protocols.

The flow sheet shown in FIG. 11 represents a system in which a delinquent fee is paid upfront by the business enterprise C. Accordingly, under the contractual arrangements between the funding party F and the business enterprise C, the business enterprise C has agreed to pay half a percent (or any other agreed percentage) upfront to the funding party F. Therefore, at step 404, the business enterprise C pays half a million dollars to the funding party F, which is received at step 403.

During the period 2-30 days after generation of the invoices, the consumers D pay a proportion of the outstanding invoices back to the client C. For example, at reference numeral 406, the consumers D pay a total of 55 million dollars to the client C, which is received at reference numeral 408.

At day 30, the client C has received payments totalling 55 million dollars (say) of the total invoices of 100 million dollars. Thus, 45 million dollars remains outstanding. Under the contractual arrangements between client C and funding party F, the funding party F transfers that difference of 45 million dollars to the client C. In this case, the amount of money transferred to client C at 30 days corresponds to the amount of outstanding invoices at 30 days.

Thus, at step 409, the funding party F transfers $45 million to the client C, which is received at step 410.

The unpaid $45 million in invoices owed by consumers D to client C attracts default interest charges. This is shown at step 411. The default interest charges start accruing at day 30. The consumers D, at 412, pay some of the outstanding invoices plus default interest, which is received by the client C at step 413. At day 60, the client C transfers the payments received from days 30 to 60 (excluding the default interest) to the funding party F, at step 414. The default interest is not paid at this stage as the half million dollars transferred to funding party efforts step 403 is effectively an upfront default interest charged on late payment of debts.

With regard to invoices outstanding beyond the delinquent period, default interest is charged in the same fashion as shown in FIG. 5.

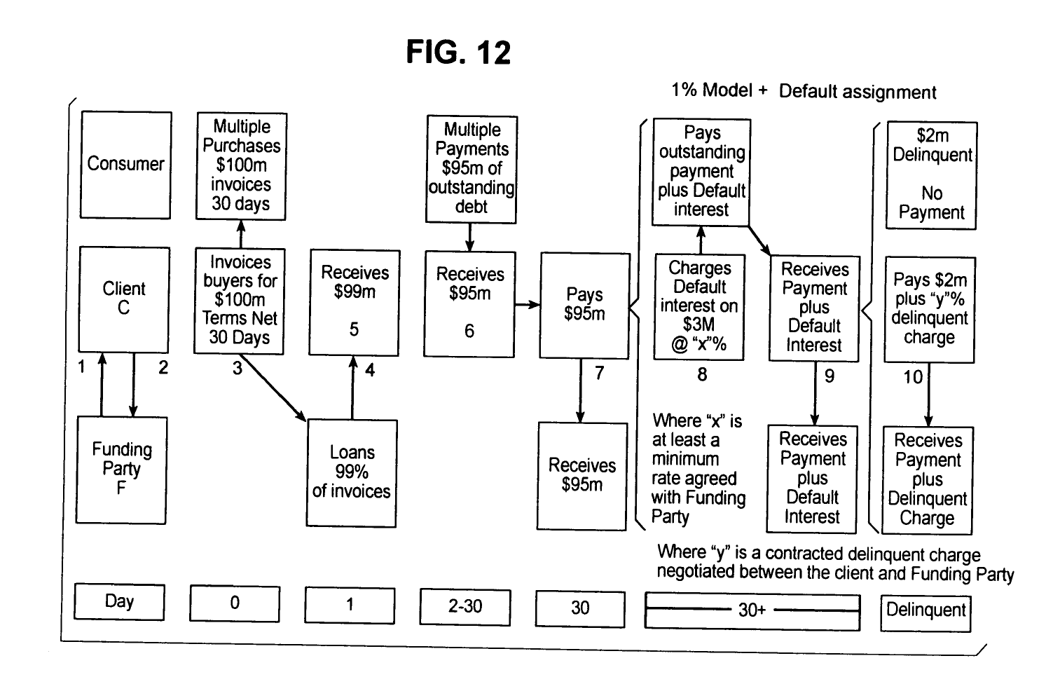

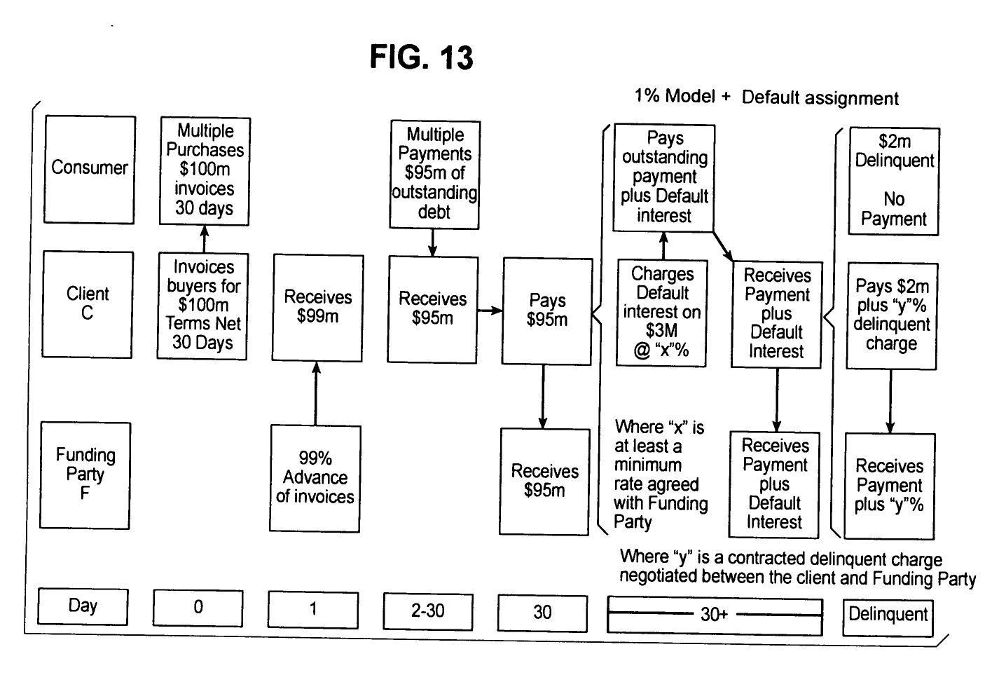

FIGS. 12 and 13 show further flow sheets in accordance with embodiments of the present invention. Those figures are self explanatory.

FIGS. 14 to 23 show flow sheets of separate components or steps of various embodiments of the present invention.

FIG. 14 shows the steps and systems required for the business enterprise to make a request for funding from the funding party and for the funding party to transfer the funds to the business enterprise. In FIG. 14, the funding party is represented by the boxed labelled “FP”, the business enterprise is represented by the box labelled “BE” and a customer of the business enterprise is represented by the box labelled “Customer”.

Prior to making a request for funds, the funding party and the business enterprise typically engage in a period of negotiations during which the terms and conditions between the parties are settled. Without limiting the generality of the present invention, some typical terms and conditions may be as follows:

funding requests made by the business enterprise to the funding party are based upon the total of all invoices issued by the business enterprise;

funds transferred from the funding party to the business enterprise total are defined percentage of the total of the invoices, for example, the funds transferred equate to 98.5% of the total represented by the invoices included in the request for funding,

invoices not paid after 30 days attract penalty interest.

Turning now to FIG. 14, the following steps take place using the platform or systems as described:

(a) The business enterprise generates an invoice and forwards the invoice to customer, as shown at line 601.

(b) The business enterprise updates its records, in this case its accounts receivable ledger, to reflect that the invoice has been issued to the customer. The records are updated to include details of the name of the customer, the date the invoice issued and the total amount payable on the invoice. This updating step is shown schematically by arrowed line 602.

(c) In order to make a request for funding, the business enterprise provides the requisite information to the funding party. This is shown schematically by arrow 603. The information that is transferred from the business enterprise to the funding enterprise will typically include details of all the invoices issued in a particular period by the business enterprise and the total amount invoiced during that period. The period may range from a single day to a 30 day period. Other periods may also be used in accordance with the present invention.

(d) Upon receipt of the request of funds, the funding party conducts its approval process, approves the funds and updates its records. This is shown schematically at 604.

(e) When the funding request has been approved by the funding party, the funds are transferred from the funding party to the business enterprise (refer to 605 in FIG. 14). At the same time, the funding party gives notification to the business enterprise that the funds have been transferred. This is shown schematically at 606.

With reference to FIG. 14, it can be seen that the computer system required to implement the steps of the invention shown in FIG. 14 includes at least the following:
an accounts receivable program operated by the business enterprise;
a database operated on the funding parties computer or computer network, which database can receive and store the accounts receivable information received from the accounts receivable program of the business enterprise;
appropriate information transfer capability, including appropriate interfaces to enable the information sent by the business enterprise to be received by the funding enterprise (and vice versa) and appropriate security protocols;
an electronic funds transfer system. The electronic funds transfer system may be provided by a third party, such as a bank with which the funding party has an arrangement for transferring the funds. It will be appreciated that separate contractual arrangements are likely to exist between the funding party and bank in relation to the funds transfer;
a funds transfer notification system that enables the funding party to notify the business enterprise that the funds have been transferred. This may be as simply as an automatically generated email or an automatically generated deposit slip confirming that the funds have been deposited into the business enterprises bank account; and
appropriate interfaces to enable the various parts of the platform to communicate with each other.

It will be appreciated that the request for funds may be taken to have been made upon receipt by the funding party of the information described with reference to 603 in FIG. 14. Thus, in the platform or system of the present invention, the request means and the information transfer means may be one and the same.

FIG. 15 shows schematically the sequence of events that occurs in an embodiment of the present invention when a customer of the business enterprise pays an account. In the flow sheet shown in FIG. 15, the business enterprise has retained responsibility for collecting payment of accounts from its customers. This is desirable as the important client relationship between the customer and the business enterprise can thereby be maintained.

In FIG. 15, the customer remits payment to the business enterprise, as shown by 610. When the business enterprise receives payment, the business enterprise updates its records, for example, as shown by line 611. In particular, the records of the business enterprise are updated to record the fact that the customer has paid the account. The business enterprise then notifies the funding party that the account has been paid, ass shown schematically at 612. The business enterprise also remits the funds received from its customer in payment of the account to the funding party as shown schematically at 613. The funding party then updates its records, as shown schematically at 614, to show that the account has been paid and to record that payment has been received from the customer.

In the embodiment of FIG. 15, the payment tracking component of the platform includes the accounting platform operated by the business enterprise, the accounting platform operated by the funding party and the information transfer platform that transfers information between the accounting platforms. The information transfer platforms may include an appropriate interface to enable the accounting platforms of the business enterprise and the funding party to communicate and exchange information. The interface may include appropriate scripts or programming to ensure compatibility between the platforms and to ensure that relevant data is placed in the appropriate data fields.

In the embodiment shown in FIG. 15, the terms and conditions of the contractual arrangements between the funding party and the business enterprise may require that the transfer of funds from the business enterprise to the funding party (as shown at 613) occurs upon receipt of the payment from the customer by the business enterprise. For example, the business enterprise may be required to remit a daily total of invoices paid to the funding party.

Although FIG. 15 shows remittance of the funds at 613 from the business enterprise directly to the funding party, it will be appreciated that the remittance of funds may occur from a bank account operated by the business enterprise to a bank account operated by the funding party, or to any other destination specified by the funding party, for example, to a loan account.

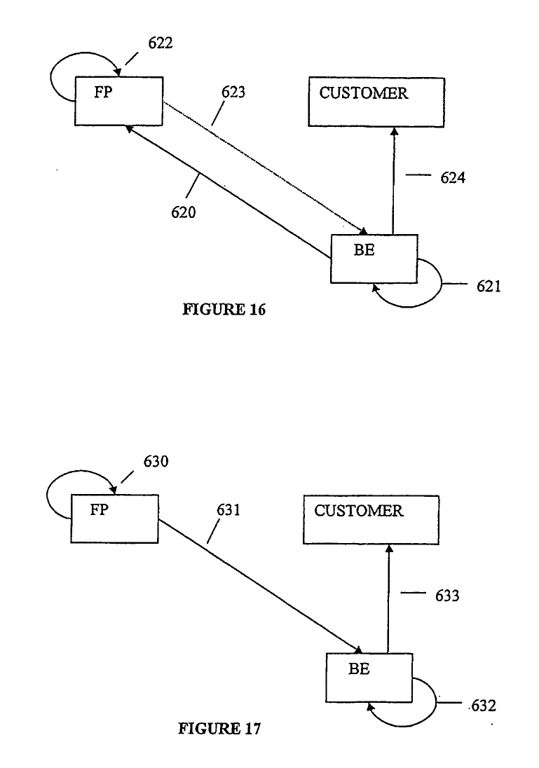

FIG. 16 shows a schematic diagram of one possible scenario that occurs when an account remains unpaid by a customer after normal trading terms such as after 30 days. In FIG. 16, the business enterprise retains responsibility for collecting its account receivable.

After normal trading terms have expired (for example, after 30 days from the date of invoice), the business enterprise conducts an audit run through its accounting platform and obtains details on all invoices that have fallen into greater than 30 days from date of invoice without payment. The business enterprise collects this information and forwards it to the funding party, as shown schematically at 620. Typically, at the same time, the business enterprise updates its records, as shown schematically at 621. Upon receipt of the information relating to unpaid accounts, the funding party also updates its records, as shown at 622, so that the records of the funding party accurately reflect the unpaid accounts. It will be appreciated that the accounting platform used by the funding party is frequently and regularly updated with information in relation to accounts paid by customers of the business enterprise. In such cases, it will be appreciated that the accounting platform operated by the funding party can also determine which accounts remain unpaid as at 30 days after date of invoice. This can provide an important audit check for the funding party to ensure that the records of the business enterprise are being kept up to date.

Upon receipt of the information in relation to unpaid accounts (or upon generation of its own list of unpaid accounts), the funding party may then issue a notification to the business enterprise that those accounts are subject to penalty payments or penalty interest. This is shown schematically by dashed line 623. It would be appreciated that this step is optional as the accounting platform used by the business enterprise should suitable automatically generate such information in relation to the unpaid accounts. Finally, the business enterprise may either issue a further invoice relating to the penalty payment or notify the customer of the levy of the penalty payment. This is shown schematically at 624.

When payment of the account and the penalty payment are received from the customer, this payment is processed as shown with reference to FIG. 15.

FIG. 17 shows an alternative embodiment for dealing with non-payment or late payment of accounts. In FIG. 17, at the end of normal trading terms (for example, 30 days after date of invoice), the accounting platform operated by the funding party analyses the date in response to accounts that have been paid (using the account payment tracking part of the platform in the information received by way of information transfer from the business enterprise in relation to the accounts that have been paid), to generate a list of accounts that remain unpaid (shown schematically at 630). This information is transferred, as shown schematically at 631, to the business enterprise. The business enterprise updates its records at 632 and issues invoices all relating to the penalty payments arising to its customers, as shown schematically at 633.

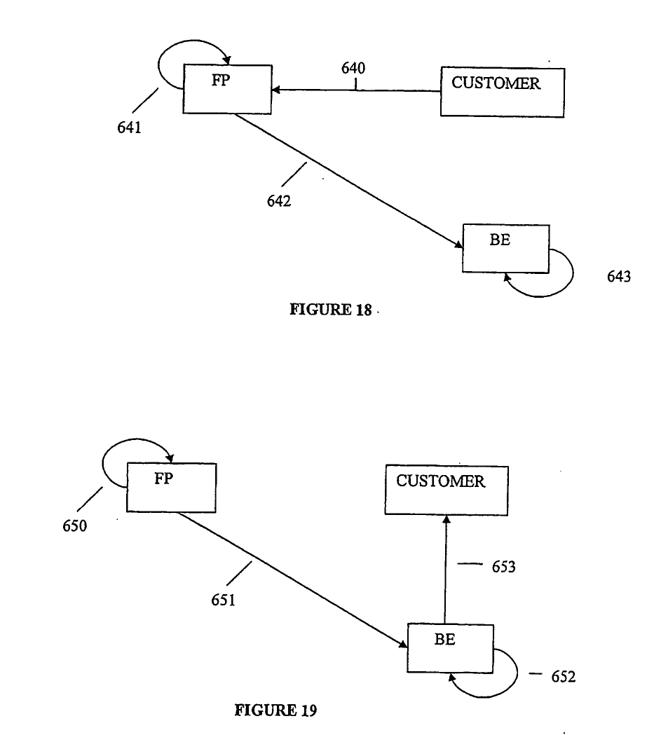

FIG. 18 shows another alternative embodiment for processing payment of accounts received from the customer. In the embodiment shown in FIG. 18, the funding party assumes responsibility for collection of accounts. This may occur, for example, if the funding patty also provides collection mechanisms or collection points for receiving payments of accounts from the customers of the business enterprises. For example, the funding party may provide an electronic, on-line or telephonic bill paying service by which customers of the business enterprise can pay their accounts. To facilitate this, the invoice received by the customer will normally include instructions as to how to pay that invoice. These instructions may consist of or include details relating to the bill payment service provided by the funding party.

In the embodiment shown in FIG. 18, the customer pays his bill, as shown schematically at 640, and remits the money to the funding party. The funding party updates its internal records to record payment of that account. This is shown at 641. The funding party also informs the business enterprise that the account has been paid (shown schematically at 642). The business enterprise then updates its internal records, as shown schematically at 643.

FIG. 19 shows one embodiment for managing non-payment of accounts under the payment scenario discussed in FIG. 18 (in which the customers pay invoices directly to the funding party). In the embodiment shown in FIG. 19, at the end of the normal payment period (for example, 30 days after the date of the invoice), the funding party analyses its records and obtains a list of accounts that remain unpaid at the end of normal trading terms. This list may include full details of all unpaid accounts together with a total amount of the unpaid accounts remaining outstanding. This analysis of records is shown schematically at 650 in FIG. 19. The funding party then notifies the business enterprise of the unpaid accounts. In particular, at 651, information relating to the unpaid accounts is transferred to the business enterprise, the business enterprise thereafter updates its own records at 652 and subsequently issues further invoices relating to penalty payments or notifications that penalty payments have now risen to the customer (which is shown schematically at 653).

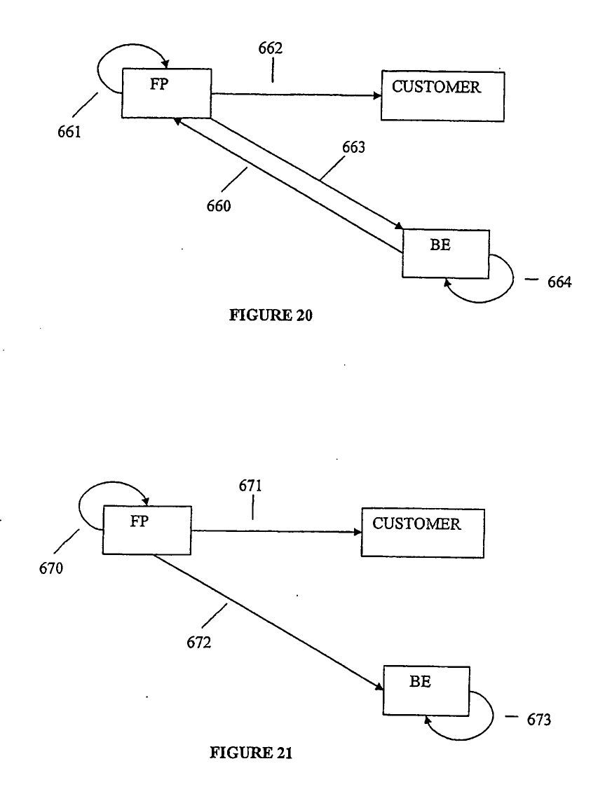

FIG. 20 shows a further embodiment of the present invention in which the funding party has assumed responsibility for issuing invoices. In the embodiment shown in FIG. 20, the business enterprise notifies the funding party of the invoices to generate. This is shown schematically at 660. The information provided by the business enterprise to the funding party includes the name of the customer, the date of the invoice to be generated and the total amount owing on each particular invoice. At 661, the funding party updates its records to include the information relating to the invoices to be generated and generates the invoices and sends them to the customer (see 662). The funding party then transfers information in relation to the invoices generated to the business enterprise, as shown at 663. The business enterprise then updates its own records, as shown at 664. Suitably, the business enterprise conducts an audit check of the data received at step 663 in order to ensure that the correct invoices have been generated. If there are any errors noticed, further information is transferred to the funding party, together with a request to rectify any errors.

FIG. 21 shows one embodiment of actions that may occur for non-payment or late payment of accounts under the invoicing scenario outlined with reference to FIG. 20. In FIG. 21, the funding party updates its records at the end of the normal term for payment. This is shown schematically at 670. This updating of the records generates a list of unpaid accounts. At 671, the funding party issues either invoices in relation to penalty interest or penalty payments or notification to the customers that penalty interest or payments are now payable. The funding party also transfers information to the business enterprise in relation to the unpaid accounts, as shown schematically by 672. The business enterprise updates its records as shown at 673, to include details of unpaid accounts.

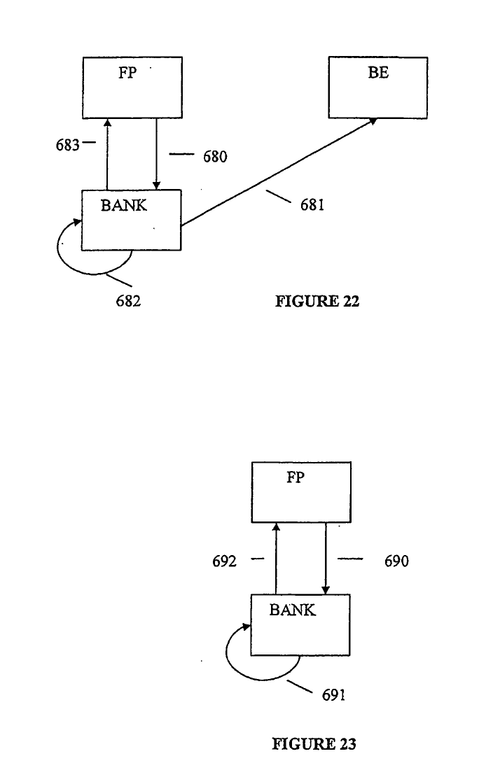

FIG. 22 shows one embodiment of transferring the approved funds from the funding party to the business enterprise. In the embodiment shown in FIG. 22, the funding party has an arrangement, typically a contractual arrangement, with a bank. It is the bank that ultimately supplies the funds to the business enterprise but those funds are supplied from the bank to the business enterprise under the provisions of a contractual arrangement or funding agreement between the bank and the funding party. In the embodiment shown in FIG. 22, the funding party advises the bank of approval of the funding (as shown at 680). This advice includes the total amount of funds approved for transfer to the business enterprise. The bank subsequently undertakes any electronic transfer of funds at 681 to transfer the funds to the business enterprise. The bank updates its internal records at 682 to reflect the transfer of funds to the business enterprise. This update of internal records at the bank typically involves the bank updating details of a loan account or a line of credit that accrues to the funding party. The bank then confirms transfer of the funds at 683 with the funding party.

FIG. 23 shows one possible embodiment for end of month processing and transactions between the funding party and the bank. In one embodiment of the present invention, the funding party receives payment continuously throughout the month from the business enterprise (with these payments being received as the customers of the business enterprise pay their accounts). However, the funding party is suitably only required to remit funds back to the bank at the end of every month.

In FIG. 23, at the end of each month, the funding party notifies the bank of payments received and remits those funds to the bank (as shown at 690). The bank updates its internal records (as shown at 691) and provides information to the funding party as to the state of its account (as shown at 692).

The method, system and platforms of the present invention may comprise a number of different combinations of the parts of the methods, systems and platforms shown separately in respective of FIGS. 14 to 23.

The funds transfer means may comprise a third party funds transfer platform. Accordingly, the systems and platforms of the present invention may also be provided without the funds transfer means.

The systems and platforms in accordance with the present invention will utilise computer programs or computer software. The actual computer language and coding used in such programs or software may vary and still fall within the present invention, provided that the functionality of the programs or software meets the requirements of the present invention Persons skilled in computer programming will readily be able to develop appropriate software for use in the present invention.

Those skilled in the art will appreciate that the present invention may be subject to variations and modifications other than those specifically described. It is to be understood that the present invention encompasses all such variations and modifications that fall within its spirit and scope.

The claims defining the invention are as follows:

1. A method for providing funds to a first party based upon accounts receivable due to a first party, the method comprising:
(a) calculating an amount of accounts receivable due to the first party from accounts receivable debtors of the first party or from a portion of the accounts receivable debtors;
(b) transferring funds from a second party to the first party based on the amount of accounts receivable due to the first party as calculated in step (a) above; and
(c) collecting the accounts receivable and any applicable penalty payments from the accounts receivable debtors, the collected accounts receivable and applicable penalty payments being provided to the second party.

2. A method as claimed in claim 1 wherein the amount of funds transferred at step (b) equals the amount calculated at step (a).

3. A method as claimed in claim 1 wherein the amount of funds transferred at step (b) equals a proportion of the amount calculated at step (a).

4. A method as claimed in claim 1 wherein the amount calculated in step (a) is the total amount owing to the first party from all accounts receivable of the first party arising over a period of time.

5. A method as claimed in claim 1 wherein the amount calculated in step (a) is determined by:
(i) calculating the total accounts receivable owing to the first party to obtain a first amount;
(ii) calculating a provision for current accounts receivable likely to be paid within normal trading terms;
(iii) deducting the provision of step (ii) from the first amount to determine a second amount.

6. A method as claimed in claim 5 wherein the first party provides discounts or concessions or settlement fees or accepts a lower amount for early payment or on-time payments of debts and step (ii) further comprises making a second provision equal to the discount applicable to the amount of accounts receivable within normal trading terms and step (iii) further comprises deducting the provision and the second provision from step (ii) from the amount calculated in step (i).

7. A method as claimed in claim 1 wherein the method includes the steps of:
(a) making an initial calculation of an amount of accounts receivable due to the first party from the accounts receivable debtors or from a portion of the accounts receivable debtors of the first party;
(b) transferring funds from a second party to the first party equal to the initial amount calculated in step (a) above;
(c) collecting the accounts receivable and applicable penalty payments from the accounts receivable debtors, the collected accounts receivable and applicable penalty payments being provided to the second party.
(d) performing a subsequent calculation within a predetermined period of a previous calculation, said subsequent calculation calculating a subsequent amount of accounts receivable due to the first party from the accounts receivable debtors or from a portion of the accounts receivable debtors of the first party that have arisen in the period between the previous calculation and the subsequent calculation;
(e) transferring funds equal to the subsequent amount from the second party to the first party; and
(f) repeating steps (c) to (e) as required.

8. A method as claimed in claim 1 wherein the funds are transferred to the first party within 0-3 days after issuance of the invoices.

9. A method as claimed in claim 1 wherein step (a) comprises:
(a) generating a plurality of accounts;
(b) entering details of the plurality of accounts into a computer program or computer database; and
(c) calculating the amount of accounts receivable from the details in the computer program or the computer database.

10. A method as claimed in claim 1 where as payment of invoices are collected, the computer records of the first party and the second party are updated.

11. A method as claimed in claim 3 wherein the proportion equals an agreed percentage of less than 100%.

12. A method as claimed in claim 1 wherein step (b) comprises an electronic transfer of funds.

13. A method for providing funds to a first party comprising:
(a) estimating revenue for the first party for an upcoming period;
(b) transferring funds from the second party to the first party based on the estimated revenue; and
(c) providing collected revenue and any applicable penalty payments arising from the revenue generated during the period to the second party.

14. A method as claimed in claim 13 further comprising the step of issuing invoices by the first party in relation to sales for goods or services provided during the period and step (c) comprises collecting money from customers or clients of the first party due to debts arising from invoices issued by the first party during the period, the collected money including any applicable penalty payments.

15. A method as claimed in claim 13 further comprising:
(a) estimating revenue for the first party for an upcoming period;
(b) transferring funds from the second party to the first party based on the estimated revenue;
(c) (i) generating invoices arising from sales or other revenue generation activity by the first party during the period;
(c) (ii) collecting payment in respect of the invoices, said payment including any applicable penalty payments; and
(c) (iii) providing the collected payments, including any applicable penalty payments, to the second party.

16. A method as claimed in claim 12 wherein the amount of funds transferred at step (b) equals a percentage of the amount estimated in step (a).

17. A method for providing funds to a business enterprise comprising:
(a) calculating an amount due to the business enterprise, the amount calculated from accounts receivable due to the business enterprise or from an estimation of revenue for an upcoming period;
(b) calculating funds payable by a funding enterprise to the business enterprise, the calculation of the funds being based upon the amount calculated in step (a);
(c) transferring the funds to the business enterprise;
(d) recovering money from customers of the business enterprise; and
(e) providing the recovered money to the funding enterprise, the recovered money including any applicable penalty payments due to the business enterprise, said recovered money being provided to the funding enterprise after the money has been recovered from customers or clients of the business enterprise.

18. A method as claimed in claim 17 wherein the business enterprise collects payments from its customers and remits those payments to the funding party when or shortly after those payments are made.

19. A method for providing funds from a funding enterprise to a business enterprise applies for the funds, the funding enterprise transfers the funds to the business enterprise and the business enterprise repays the funds to the funding enterprise, characterised in that the funding enterprise and business enterprise enter into a contractual agreement in which repayments are made by the business enterprise on specified dates or at specified time periods by the amount of the repayment is calculated by determining an amount of funds received by the business enterprise in payment of accounts by customers or clients of the business enterprise.

20. A method for providing funds from a funding party to a business enterprise, the method including the steps of the business enterprise making application to the funding enterprise for the funds, the funding enterprise reviewing and approving the application for funds, the funding enterprise transferring the funds to the business enterprise, the business enterprise receive payment for goods and/or services from its customers or clients, and the business enterprise making repayments to the funding enterprise based upon payments received by the business enterprise from its customers.

21. A method as claimed in claim 17, wherein the funding party provides a collection mechanism for receiving payments from customers of the business enterprise.

22. A system for implementing the method claimed in claim 17, with the system including calculation means for calculating an amount of accounts receivable due to the first party from the accounts receivable debtors or from a portion of the accounts receivable debtors of the first party or from anticipated future revenue of the first party, funds transfer means for transferring funds from a second party to the first party, said funds transferred being equal to the amount calculated by the calculation means, and monitoring means for monitoring collection of the accounts receivable and applicable penalty payments.

23. A system as claimed in claim 22 wherein the calculation means comprises data entry means for entering data into a computer program or computer database and a calculating program for calculating the amount based on the data entered into the computer program or the computer database.

24. A system as claimed in claim 22 wherein the monitoring means includes data entry means for entering data on the collection of accounts receivable and applicable penalty payments.

25. A system as claimed in claim 23 wherein the data entry means for entering data into a computer program or computer database in relation to the accounts receivable comprises automated data entry means for automatically entering data when accounts are generated.

26. A system as claimed in claim 22 further including information transfer means for transferring information on the accounts receivable from the first party to the second party.

27. A platform for implementation on one or more computers, the platform comprising request means for a business enterprise to request funds from a funding party, information transfer means to transfer information relating to accounts receivable or anticipated future revenue for the business enterprise to the funding party, funds transfer means to transfer funds from the funding party to the business enterprise and payment tracking means to track payments made by customers or clients of the business enterprise.

28. A platform as claimed in claim 27 wherein the request means is loaded onto one or more computers operated by or on behalf of the funding party.

29. A platform as claimed in claim 27 wherein the request means is accessible from one or more computers operated by or on behalf of the business enterprise.

30. A platform as claimed in claim 27 wherein the information transfer means is operable to transfer information relating to the accounts receivable of the business enterprise from the business enterprise to the funding party.

31. A platform as claimed in claim 27 further comprising decision making software to facilitate making of a decision as to whether or not to approve the request for funds.

32. A platform as claimed in claim 27 wherein the payment tracking software comprises payment tracking software operated by the business enterprise, or payment tracking software operated by the funding party, or both.

33. A platform as claimed in claim 32 wherein the payment tracking software is operated by the funding party and acts to check payment tracking conducted by the business enterprise.

34. A platform as claimed in claim 27 further comprising one or more interfaces to facilitate transfer of information between the business enterprise and the funding party.
